(19) United States
(12) Patent Application Publication
(10) Pub. No.: US 2010/0011610 A1
(43) Pub. Date: Jan. 21, 2010

(54) FLUIDIZED SPRAY DRYING

(75) Inventors: Kevin John Bittorf, Cambridge, MA (US); Jeffrey P. Katstra, South Boston, MA (US); Filipe Gaspar, Oeiras (PT)

Correspondence Address: Honigman Miller Schwartz & Cohn LLP/VPI, 444 West Michigan Avenue, Kalamazoo, MI, 49007-3714, US

(73) Assignee: Vertex Pharmaceuticals Incorporated, Cambridge, MA (US)

(21) Appl. No.: 12/488,754

(22) Filed: Jun. 22, 2009

Related U.S. Application Data
(63) Continuation of application No. PCT/US2007/088837, filed on Dec. 26, 2007.
(60) Provisional application No. 60/973,845, filed on Sep. 20, 2007.
(60) Provisional application No. 60/871,695, filed on Dec. 22, 2006.

(51) Int. Cl. F26B 3/12

(52) U.S. Cl. 34/359

(57) ABSTRACT

Methods of fluidized spray drying VX-950 are described.

### TECHNICAL FIELD

This invention relates to fluidized spray drying and the product resulting therefrom.

### BACKGROUND

It is known in the pharmaceutical arts that low-solubility drugs often show poor bioavailability or irregular absorption, the degree of irregularity being affected by factors such as dose level, fed state of the patient, and form of the drug.

Solid dispersions of a drug in a matrix can be prepared by forming a homogeneous solution or melt of the drug and matrix material followed by solidifying the mixture by cooling or removal of solvent. Such solid dispersions of drugs often show enhanced bioavailability when administered orally relative to oral compositions comprising undispersed drug.

Spray drying is the most widely used industrial process involving particle formation and drying, and can be used to produce solid dispersions of drug compounds. It is highly suited for the continuous production of dry solids in either powder, granulate or agglomerate form from liquid feedstocks as solutions, emulsions and pumpable suspensions. Therefore, spray drying is a useful process where the end-product must comply to precise quality standards regarding particle size distribution, residual moisture content, bulk density, and particle shape.

Spray drying generally involves the atomization of a liquid feed solution into a spray of droplets and contacting the droplets with hot air or gas in a drying chamber. The sprays are generally produced by either rotary (wheel) or nozzle atomizers. Evaporation of moisture from the droplets and formation of dry particles proceed under controlled temperature and airflow conditions.

### SUMMARY

The inventors have discovered that fluidized spray drying (FSD) of a feed solution (e.g., of a drug and matrix (e.g., polymer) material, e.g., dissolved or suspended in a solvent(s)) can improve the properties of the resulting product (e.g., composition, e.g., agglomerated product, e.g., a solid dispersion such as an amorphous solid dispersion of the drug or therapeutic agent), e.g., for further downstream processing. For example, the composition, e.g., dispersion, obtained by fluidized spray drying can have increased particle size and/or product density, and/or reduced “fines” (particles with geometric median diameters of less than 10 microns), e.g., as compared to a composition prepared by conventional spray drying. As a result, these dispersions can have reduced spans, which in turn yields improved flowability. Such a dispersion can, for example, be directly compressed, e.g., into an oral dosage form with no or minimal subsequent processing steps.

This process is especially useful for the preparation of compositions (e.g., containing a compound, e.g., a therapeutic agent (e.g., a drug)) having poor aqueous solubility. For example, because less downstream processing may be required with dispersions obtained by the FSD process, a compound in the dispersion (e.g., a poorly soluble drug) may be more stable and have less opportunity to convert to a crystalline form, e.g., from an amorphous form.

In one aspect, the disclosure features a method of fluidized spray drying. The method includes: preparing a liquid feed solution (e.g., containing a compound of interest such as a drug or pharmaceutical compound, and optionally a polymer(s) and/or surfactant(s), dissolved or suspended in solvent(s)); atomizing (e.g., with a pressure nozzle, a rotary atomizer or disk, two-fluid nozzle or other atomizing methods) the feed solution upon delivery into the drying chamber of a spray dryer, e.g., operating in FSD mode; drying the atomized feed solution in the drying chamber with heated air or a heated gas (e.g., nitrogen) to obtain a product, wherein larger (e.g., non fines, e.g., particles with geometric median diameters greater than or equal to about 10 microns) particles of product separate out, e.g., drop out, while fines are carried by a stream of air or gas up to the top of the drying chamber (e.g., by natural convection) and to a cyclone, and re-introducing (e.g., coaxially surrounding the liquid flow of feed solution or tangentially to the drying chamber) the fines into the drying chamber, wherein the re-introduced fines can agglomerate with newly formed product to generate an agglomerated product, wherein if the agglomerated product is large enough, it will separate out, if it is not large enough to separate out, the agglomerated product will be carried by convection to the top of the chamber and to the cyclone and re-introduced into the chamber.

In some embodiments, the method includes: preparing a liquid feed solution of VX-950, wherein the feed solution comprises about 83% VX-950 and about 17% HPMCAS dissolved in methylene chloride; atomizing the feed solution upon delivery into the drying chamber of a spray dryer operating in a closed cycle mode; drying the atomized feed solution in the drying chamber with heated nitrogen to obtain a product, wherein the product is carried by a stream of gas out of the drying chamber and into a cyclone, re-introducing the product into the drying chamber, wherein the re-introduced product can agglomerate with newly formed product to generate agglomerated product; collecting the agglomerated product in a first fluidizing chamber; discharging the agglomerated product from the first fluidizing chamber to a second fluidizing chamber, wherein a post-drying process occurs; transferring the agglomerated product from the second fluidizing chamber to a third fluidizing chamber, wherein the agglomerated product is cooled.

In some embodiments, the agglomerated product has a residual moisture content of less than about 2% by weight, for example less than about 2% by weight of residual water and/or solvent such as methylene chloride.

In some embodiments, the agglomerated product is chemically stable for at least 2 years at room temperature.

In some embodiments, the agglomerated product is physically stable for at least 2 years at room temperature.

In some embodiments, the method further includes collecting the agglomerated product in a first fluidizing chamber. In some preferred embodiments, the method further includes discharging the agglomerated product from the first fluidizing chamber to a second fluidizing chamber, wherein a post-drying process occurs. In some more preferred embodiments, the method further includes transferring the agglomerated product from the second fluidizing chamber to a third fluidizing chamber, wherein the agglomerated product is cooled.

In some embodiments, the method further includes directly compressing the agglomerated product. In some preferred embodiments, the agglomerated product is directly compressed into an oral dosage form (e.g., tablet). In some embodiments, wherein the oral dosage form is coated.

In some embodiments, the fines are re-introduced into the drying chamber coaxially surrounding the liquid flow of feed solution.

In some embodiments, the fines are re-introduced tangentially to the drying chamber.

In some embodiments, the feed solution is dried with a gas such as nitrogen.

In some embodiments, the feed solution comprises a drug. In some embodiments, the drug is a small molecule drug, for example, a drug having a molecular weight of less than about 1000 Daltons (e.g., less than about 750 Daltons or less than about 500 Daltons). In some embodiments, in the drug is selected from the group consisting of: analgesics, anti-inflammatory agents, antihelminthics, anti-arrhythmic agents, anti-bacterial agents, anti-viral agents, anti-coagulants, anti-depressants, anti-diabetics, anti-epileptics, anti-fungal agents, anti-gout agents, anti-hypertensive agents, anti-malarials, anti-migraine agents, anti-muscarinic agents, anti-neoplastic agents, erectile dysfunction improvement agents, immunosuppressants, anti-protozoal agents, anti-thyroid agents, anxiolytic agents, sedatives, hypnotics, neuroleptics, β-blockers, cardiac inotropic agents, corticosteroids, diuretics, anti-Parkinsonian agents, gastro-intestinal agents, histamine receptor antagonists, keratolyptics, lipid regulating agents, anti-anginal agents, Cox-2 inhibitors, leukotriene inhibitors, macrolides, muscle relaxants, nutritional agents, opiod analgesics, protease inhibitors, sex hormones, stimulants, muscle relaxants, anti-osteoporosis agents, anti-obesity agents, cognition enhancers, anti-urinary incontinence agents, nutritional oils, anti-benign prostate hypertrophy agents, essential fatty acids, and non-essential fatty acids. In some embodiments, the drug is a poorly soluble drug.

In some preferred embodiments, the drug is an anti-viral agent, for example, an antiviral agent used to treat hepatitis C (HepC), such as a HepC protease inhibitor. In some most preferred embodiments, the drug is VX-950:

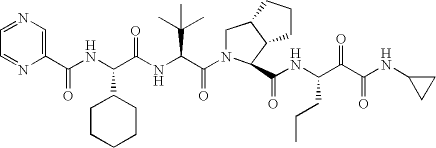

In some embodiments, the feed solution comprises VX-950. In preferred embodiments, the VX-950 comprises between about 10% and 90% (e.g., between about 20% and about 80%; between about 30% and about 70%; between about 40% and about 60%; between about 65% and about 85%; about 80% (e.g., about 83%) of the solids dissolved in the feed solution.

In some embodiments, the feed solution comprises a solvent, such as methylene chloride or acetone. In some embodiments, the solvent comprises methylene chloride and acetone. In preferred embodiments, the solvent comprises from about 0% to about 30% acetone and from about 70% to about 100% methylene chloride. In some embodiments, the solvent comprises from about 0% to about 40% acetone and from about 60% to about 100% methylene chloride.

In some embodiments, the solvent comprises a non-volatile solvent (e.g., water or glacial acetic acid).

In some embodiments, the feed solution comprises a surfactant, e.g., vitamin E or a derivative thereof (e.g., vitamin E TPGS), or sodium lauryl sulfate (SLS). In some embodiments, the surfactant is present in an amount of between about 0.1% and about 10% (e.g., up to about 5%, up to about 4%, up to about 3%, up to about 2%, at about 1%).

In some embodiments, the feed solution comprises a plurality of polymers (e.g., one or more than one water-soluble polymer or partially water-soluble polymer). In some embodiments, the polymers comprise between about 10% and 90% (e.g., between about 20% and about 80%; between about 30% and about 70%; between about 40% and about 60%; between about 15% and about 35%; about 20% (e.g., about 17%) of the solids dissolved in the feed solution. In some embodiments, the plurality of polymers comprises a cellulose polymer. In some embodiments, the cellulose polymer is hydroxypropylmethylcellulose (HPMC). In other embodiments, the cellulose polymer is hydroxypropylmethylcellulose acetate succinate (HPMCAS). In some embodiments, the plurality of polymers comprises two cellulose polymers. In preferred embodiments, one of the two cellulose polymers is hydroxypropylmethylcellulose (HPMC). In other preferred embodiments, one of the two cellulose polymers is hydroxypropylmethylcellulose acetate succinate (HPMCAS), e.g., HG grade HPMCAS. In other embodiments, the plurality of polymers comprises HPMC and HPMCAS.

In some embodiments, the feed solution comprises a surfactant or excipient. In preferred embodiments, the surfactant comprises SLS or vitamin E or a derivative thereof. In preferred embodiments, the surfactant is SLS. In other preferred embodiments, the surfactant is vitamin E or a derivative thereof (e.g., vitamin E TPGS).

In some embodiments, the feed solution comprises a polymer. In preferred embodiments, the polymer comprises between about 10% and 90% (e.g., between about 20% and about 80%; between about 30% and about 70%; between about 40% and about 60%; between about 15% and about 35%; about 20% (e.g., about 17%) of the solids dissolved in the feed solution. In other embodiments, the feed solution further comprises a surfactant or excipient, e.g., SLS or vitamin E or a derivative thereof. In preferred embodiments, the surfactant is SLS. In other preferred embodiments, the surfactant is vitamin E or a derivative thereof (e.g., vitamin E TPGS). In some embodiments, the surfactant is present in an amount of between about 0.1% and about 10% (e.g., up to about 5%, up to about 4%, up to about 3%, up to about 2%, at about 1%).

In some embodiments, the polymer comprises a cellulose polymer. In preferred embodiments, the cellulose polymer is hydroxypropylmethylcellulose (HPMC). In more preferred embodiments, the cellulose polymer is hydroxypropylmethylcellulose acetate succinate (HPMCAS).

In another aspect, the disclosure features a product produced by a method described herein.

In some embodiments, the bulk density of the product is between about 0.13 g/ml to about 0.45 g/ml, e.g., between about 0.13 g/ml to about 0.32 g/ml, e.g., about 0.25 g/ml to about 0.4 g/ml, e.g., about 0.33 g/ml to about 0.45 g/ml, or, e.g., between about 0.17 g/ml to about 0.20 g/ml.

In some embodiments, the tap density of the product is between about 0.23 g/ml to about 0.25 g/ml.

In some embodiments, the median particle size (d50) of the product is between about 40 μm and about 500 μm, e.g., between about 40 μm and about 200 μm; between about 50 μm and about 130 μm, between about 75 μm and 150 μm; between about 150 μm and about 200 μm, e.g., about 186 μm.

In some embodiments, the volumetric particle size distribution span ([d90-d10]/d50) is less than about 3.0, e.g., less than about 2.0.

In some embodiments, the percentage of fines in the product is less than about 30%, e.g., less than about 25%, less than about 20%, less than about 15%, less than about 10%, less than about 5%, less than about 4%, less than about 3%, less than about 2%, less than about 1%.

In some embodiments, the product has a residual moisture content of less than about 2% by weight.

In some embodiments, the product is chemically stable for at least 2 years at room temperature.

In some embodiments, the product is physically stable for at least 2 years at room temperature.

In another aspect, the disclosure features a pharmaceutical composition comprising the product produced by a method described herein.

In some aspects, the methods described herein employ a composition, e.g., a composition containing a compound of interest, e.g., a therapeutic agent (e.g., a drug), and optionally containing a polymer and/or surfactant.

In some embodiments, the drug is a small molecule drug, for example a drug having a molecular weight of less than about 1000 Daltons, e.g., less than about 750 Daltons or less than about 500 Daltons.

In some embodiments, the drug is a poorly soluble drug.

The drug can be selected from one of the following classifications: analgesics, anti-inflammatory agents, antihelminthics, anti-arrhythmic agents, anti-bacterial agents, anti-viral agents, anti-coagulants, anti-depressants, anti-diabetics, anti-epileptics, anti-fungal agents, anti-gout agents, anti-hypertensive agents, anti-malarials, anti-migraine agents, anti-muscarinic agents, anti-neoplastic agents, erectile dysfunction improvement agents, immunosuppressants, anti-protozoal agents, anti-thyroid agents, anxiolytic agents, sedatives, hypnotics, neuroleptics, P-blockers, cardiac inotropic agents, corticosteroids, diuretics, anti-Parkinsonian agents, gastro-intestinal agents, histamine receptor antagonists, keratolyptics, lipid regulating agents, anti-anginal agents, Cox-2 inhibitors, leukotriene inhibitors, macrolides, muscle relaxants, nutritional agents, opiod analgesics, protease inhibitors, sex hormones, stimulants, muscle relaxants, anti-osteoporosis agents, anti-obesity agents, cognition enhancers, anti-urinary incontinence agents, nutritional oils, anti-benign prostate hypertrophy agents, essential fatty acids, or non-essential fatty acids.

In some preferred embodiments, the drug is an anti-viral agent, for example an antiviral agent used to treat hepatitis C (HepC), such as a HepC protease inhibitor. In some most preferred embodiments, the drug is VX-950:

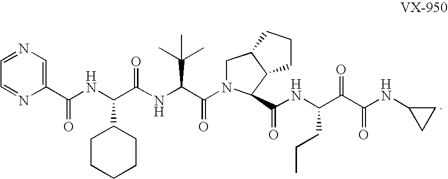

See, e.g., WO 02/018369; WO 2005/12307; and US 2006-0089385 for descriptions of VX-950 and dispersions thereof.

All herein cited patents, patent applications, and references are hereby incorporated by reference in their entireties. In the case of conflict, the present application controls.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic illustrating a spray dryer operating in fluidized spray dryer mode.

### DETAILED DESCRIPTION

The inventors have discovered that the process of fluidized spray drying (FSD) is useful for the preparation of free-flowing products containing a minimal amount of fines and with good re-dispersibility, and for the production of agglomerated or granulated products. The resulting products (e.g., compositions containing a compound of interest (e.g., a drug, e.g., a poorly soluble drug, e.g., VX-950)) can have altered (e.g., increased or decreased, e.g., as compared to the products of conventional spray drying) bulk and tap densities, and/or improved dissolution (e.g., as compared to the products of conventional spray drying). In some instances, products with lower densities, but with better flow properties, are obtained as a result of reducing the amount of fines. The product particles (e.g., agglomerates) are often of larger size than particles obtained by conventional spray drying. As a result of the modified (e.g., increased) densities and/or increased particle size, the product of FSD can be directly compressed (e.g., into oral dosage forms) with no or minimal further processing (e.g., milling, granulation, blending, and/or mixing steps).

Fluidized Spray Drying

Generally, the process of fluidized spray drying combines spray drying and fluid bed drying technologies. The product obtained can be an agglomerated product (e.g., agglomerated powders or granulates) as a result of the integrated fluid bed or belt and a multi-stage process where moist powder, produced during the first drying stage, forms agglomerates which can be post-dried and cooled in subsequent stages.

As an overview, to perform FSD, an atomizer (e.g., a pressure nozzle, a rotary atomizer or disk, a two-fluid nozzle, or other atomizing methods, such as electrostatic processes, e.g., electronic nebulization technologies) sprays a feed solution to be dried into the drying chamber of the spray dryer and down in the direction of the fluid bed. Agglomeration incorporating finer and recycled material takes place in the drying chamber, and agglomerated particles fall to the fluid bed. The feed solution contains a compound of interest (e.g., a drug, e.g., a poorly soluble drug, e.g., VX-950) and optionally other components, such as one or more polymers, and/or a surfactant. The exhaust air outlet is through the roof of the chamber, which causes further agglomeration in the zone of spraying. The agglomerated products can then be dried. The process is well suited for drying heat sensitive products, and for improving aroma retention, when appropriate. The process yields an agglomerated product, e.g., as free-flowing powders with minimal fines.

In some embodiments, the one or more components are dissolved in a solvent(s). In some embodiments, all of the components are dissolved, e.g., the feed solution is homogenous. In some embodiments, one or more components are suspended in the feed solution (e.g., the feed solution is not homogeneous).

The term “agglomerated dispersion” refers to multiple (e.g., two or more particles) particles joined together to make a larger particle.

As an example, in the spray dryer, a feed solution is sprayed from the atomization nozzle mounted on top of the drying chamber into the drying air and down the spray chamber. The vigorous fluidization of moist powder in the fluid bed located at the chamber base, plus the recycling of fines from a cyclone attachment, result in fluidized spray drying taking place in a powder-laden atmosphere. The agglomerated dispersion (e.g., powder) resulting from fluidized spray drying can be dryer than the dispersion resulting from conventional spray drying. Because the powder has a chance to circulate for longer (e.g., the powder will cycle until large enough to drop out, e.g., into a drying bed), residual water or organic volatiles in the powder can be reduced. Drying can be completed at lower powder and exhaust air temperatures, thus improving product quality while gaining from a higher thermal efficiency.

The degree of agglomeration and thus the particle size distribution can be influenced by changing the operation conditions. For example, any or all of the following parameters can be varied: C_feed: concentration of the feed solution in wt %; feed viscosity: viscosity of the feed solution that is spray dried; T_in: inlet temperature of the spray dryer; T_out: outlet temperature of the spray dryer; ΔP cyclone: differential pressure in the separation cyclone of the spray dryer (indicates the flowrate of the drying gas); P_feed_SP: feed pressure set point; kg/hr of drying gas; F_feed: flowrate of the feed solution; FR position: the position (part of the spray drying vessels) where the fines are returned, higher placement will create the most agglomerated situation (nearest nozzle), whereas lower placement will create the less or non agglomerated type of situation; T_FB1_SP: temperature set point of fluidized bed #1; T_FB2_SP: temperature set point of fluidized bed #2; T_FB3_SP: temperature set point of fluidized bed #3; V_FB1,2,3: % open fluidized bed fan valve (#1-3 respectively) position (% open); and VT-FB: fluidized bed fan. By optimizing the operation conditions, a dispersion with properties favorable for downstream processing (e.g., direct compression), can be obtained.

An adjustment to a parameter can be made and tested for its suitability in the methods described herein, and the suitability of the resulting product for later uses of the product can also be tested. For example, the inlet temperature of the spray dryer can be increased or decreased, e.g., as compared to an inlet temperature described herein (e.g., the temperature can be decreased to below 70° C.). The effects of this adjustment in inlet temperature on the properties of the resulting agglomerated product (e.g., all other parameters being unchanged) can be compared to the properties of an agglomerated product prepared as described herein (e.g., with an inlet temperature of 70° C.). An improvement in the properties (e.g., increase in particle size or increased flowability) or in the suitability of the product (e.g., for a particular application, e.g., direct compression) with the adjustment suggests that the adjustment is useful and suitable for the methods described herein.

The steps in FSD can include, for example:
preparing a liquid feed solution (e.g., containing a compound of interest, and optionally a polymer(s) and/or surfactant(s), dissolved or suspended in solvent(s));
atomizing (e.g., with a pressure nozzle, a rotary atomizer or disk, two-fluid nozzle or other atomizing methods) the feed solution upon delivery into the drying chamber of a spray dryer, e.g., operating in FSD mode;
drying the feed solution in the drying chamber with heated air or a heated gas (e.g., nitrogen) to obtain a product, wherein larger particles of product separate out, e.g., drop out, while fines are carried by a stream of air or gas up to the top of the drying chamber (e.g., by natural convection) and to a cyclone, and
re-introducing (e.g., at the top of the drying chamber or axially to the middle of the chamber) the fines into the drying chamber, wherein the re-introduced fines can agglomerate with newly formed product to generate an agglomerated product, wherein if the agglomerated product is large enough, it will separate out, if it is not large enough to separate out, the agglomerated product will be carried by convection to the top of the chamber and to the cyclone and re-introduced into the chamber. This process repeats until an agglomerated product that is large enough to drop out is formed. The fines can be re-introduced from the cyclone to the drying chamber via a feed pipe.

In some embodiments, rather than drying the feed solution with heated air or a heated gas, the feed solution can instead be spray congealed, e.g., the chamber is at room temperature (e.g., 21±4° C.) or is cooled, e.g., cooled gas (e.g., nitrogen) is used for the process.

The inventors have discovered that the location where fines are re-introduced into the drying chamber from the cyclone affects the properties of the resultant agglomerated dispersion. The introduction of fines co-axially surrounding the liquid flow of feed solution (i.e., at the top of the drying chamber) can promote a higher degree of agglomeration (e.g., because of the direct contact of the re-introduced fines with the feed solution) and can be practiced, e.g., when an increase in agglomeration is desired for a particular compound. In an alternative embodiment, the fines can be re-introduced tangentially to (i.e., on the side of) the drying chamber. The fines can be re-introduced tangentially anywhere along the side of the chamber, e.g., about ¼, about ⅓, about ½, about ⅔, or about ¾ down, etc. the side of the chamber. Re-introducing the fines tangentially can reduce the degree of agglomeration (e.g., because the liquid droplets of feed solution have dried a sufficient amount before the fines are re-introduced, allowing less time for agglomeration). The product density (e.g., bulk density) can be increased or decreased as a result. In some embodiments, product density is increased (e.g., bulk density, e.g., from 0.17 to 0.20 g/ml; and tap density, e.g., from 0.23 to 0.25 g/ml). In some embodiments, this decreased agglomeration and increased densities can be achieved while maintaining a higher median particle size (e.g., d50=186 μm), e.g., as compared to the median particle size obtained by conventional spray drying. In some embodiments, particle size is increased, e.g., as compared to the particle size obtained by conventional spray drying. Thus, in certain applications of the FSD method, it may be desirable to decrease the amount of agglomeration in order to attain increases in product density. This can be achieved, e.g., without a decrease in median particle size. Particle size can be measured, e.g., via microscopy.

FSD can further include collecting the agglomerated product in a first fluidizing chamber; which can be followed by discharging the agglomerated product from the first fluidizing chamber to a second fluidizing chamber, wherein a post-drying process can occur.

The agglomerated product (e.g., that separates out in the drying chamber) can then be transferred from the second fluidizing chamber to a third fluidizing chamber, where the agglomerated product is cooled. The agglomerated product (e.g., a solid dispersion of an amorphous compound) can then be further processed. For example, the product can be directly compressed. The product can optionally be blended with a surfactant, excipient, or pharmaceutically acceptable carrier, e.g., prior to direct compression. The product can optionally be further processed, e.g., milled, granulated, blended, and/or mixed with a melt granulate, surfactant, excipient, and/or pharmaceutically acceptable carrier.

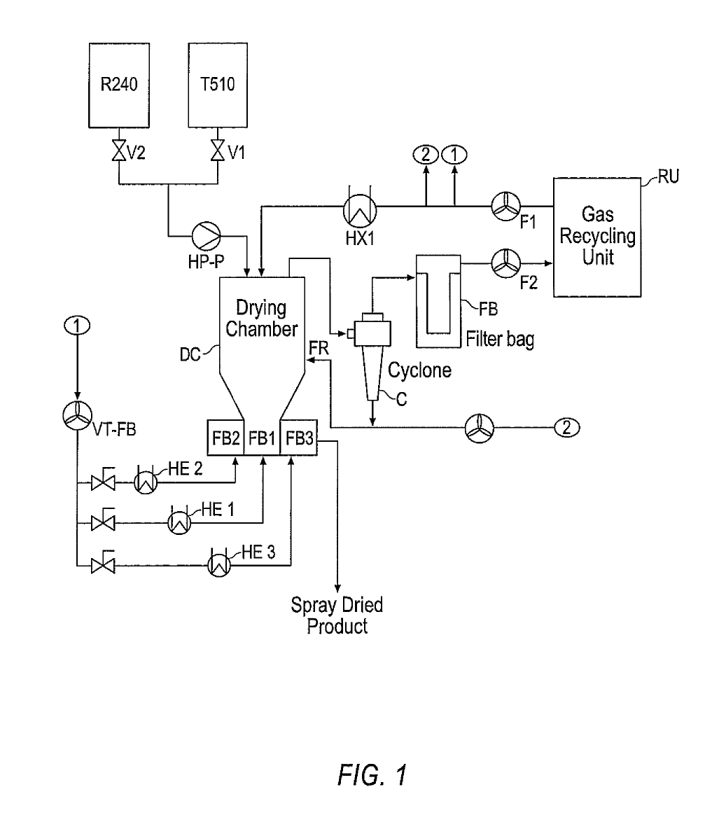

FSD can be performed in a commercial spray dryer operating in fluidized spray dryer mode (FSD mode). FSD can be accomplished in either open cycle mode or closed cycle mode (e.g., the drying gas, e.g., nitrogen, is recycled). Examples of suitable spray dryers for use in FSD include dryers from Niro (e.g., the PSD line of spray driers manufactured by Niro: PHARMASD™; Chemical or SD line dryers). The layout of an exemplary spray dryer operating in FSD mode is provided in FIG. 1. FSD can essentially be performed in any spray dryer that is configured to allow for the re-introduction of fines into the drying chamber.

Additional post drying, e.g., in a vacuum or fluidized bed dryer or a double cone or biconical post-dryer or a tumble dryer, can be performed if needed/applicable to remove further solvents. In preferred embodiments, a post-drying step is performed.

To remove the solvent or solvent mixture, vacuum drying, spray drying, fluidized spray drying, tray drying, lyophilization, rotovapping, and other drying procedures may be applied. Applying any of these methods using appropriate processing parameters, according to this disclosure, would provide VX-950 in an amorphous state in the final solid dispersion product. Upon use of appropriate conditions (e.g., low outlet temperatures in the spray dryer, use of low boiling point solvents, use of heated gas) that result in a dispersion, e.g., powder, with desirable properties (e.g., median particle size (d50) of 40-200 microns 9 e.g., 40-150 microns), powder bulk density of >0.2g/ml (e.g., 0.2 to 0.5 g/ml), preferably >0.25 g/ml, improved powder flowability (e.g., low cohesion forces, low interparticle internal friction); and/or dry powder with low OVIs, e.g., below ICH limits and/or user specifications), the dispersion can be directly compressed into a dosage form.

The FSD process can be used to improve the flow properties of compositions (e.g., a compound of interest (e.g., a drug, e.g., a poorly soluble drug, e.g., VX-950)). In some embodiments, the process of FSD increases the flowability of a product, as compared to the product obtained by conventional spray drying, without a change (e.g., increase) in product density (e.g., bulk or tap density). For example, with FSD, (e.g., as compared to conventional spray drying), the amount of fines can decrease (e.g., because the fines form agglomerates after re-introduction into the drying chamber), which may result in a tighter span and particle size distribution, thereby resulting in improved flow properties, independent of density. In some embodiments, the percentage of fines present in the product resulting from FSD is less than about 30%, e.g., less than about 25%, less than about 20%, less than about 15%, less than about 10%, less than about 5%, less than about 4%, less than about 3%, less than about 2%, less than about 1%.

The term “flowability” refers to the ability of a composition to flow. The flowability of a composition, e.g., an agglomerated dispersion or powder, can be measured in several ways. For example, the angle of repose for a given amount of powder, the time it takes the powder to pass through a hole in a funnel (flow funnel) with a given diameter, dynamic angle of repose, compressibility, Carr indices, Johanson indicizer, or minimum orifice diameter can be measured, or a Jenike and Johanson QC tester can be employed. As another option, the time for a given volume of powder to flow through well defined slits in a drum rotating with a given revolution/min is measured (e.g.,using a system developed by Niro). Flow properties include density, cohesive strength, and wall friction, and refer to the behavior of the bulk material. For a discussion of flowability and flow properties, see Prescott and Barnum, “On Powder Flowability” in Pharma. Technol. pages 60-84 (October 2000 issue).

In other embodiments, FSD increases product flowability with a concomitant increase in product density, both as compared to conventional spray drying. In still other embodiments, FSD can increase the flow properties of a product and result in a decrease in product densities, both, e.g., as compared to conventional spray drying.

In other embodiments, FSD increases product flowability with a concomitant increase in particle size, e.g., as compared to conventional spray drying.

In some embodiments, the residual moisture content in the product resulting from FSD is less than about 10%, e.g., less than about 5%, less than about 4%, less than about 3%, less than about 2%, less than about 1%.

In some embodiments, the inlet temperature is between about 50° C. and about 200° C., e.g., between about 60° C. and about 150° C., between about 70° C. and about 100° C., between about 65° C. and about 85° C., between about 70° C. and about 90° C., or between about 70° C. and about 85° C.

In some embodiments, the outlet temperature is between about room temperature (e.g., USP room temperature (e.g., 21±4° C.)) and about 80° C., e.g., between about 25° C. and about 75° C., between about 30° C. and about 65° C., between about 35° C. and about 70° C., between about 40° C. and about 65° C., between about 45° C. and about 60° C., or between about 35° C. and about 45° C.

In some embodiments, the temperature set points of the fluidized beds (the temperature for each bed being selected independently from the temperature selected for another bed) is between about room temperature (e.g., USP room temperature (e.g., 21±4° C.)) and about 100° C., e.g., between about 30° C. and about 95° C., between about 40° C. and about 90° C., between about 50° C. and about 80° C., between about 60° C. and about 85° C., between about 65° C. and about 95° C., or between about 80° C. and about 95° C.

In some embodiments, the median particle size (d50) of the product is between about 40 μm and about 500 μm, e.g., between about 40 μm and about 200 μm; between about 50 μm and about 130 μm, between about 45 μm and about 100 μm; between about 50 μm and about 90 μm; between about 50 μm and about 80 μm; between about 75 μm and 150 μm; between about 80 μm and 125 μm; between about 90 μm and 175 μm; between about 150 μm and about 200 μm, e.g., about 186 μm.

FSD can be performed on a mixture containing a compound of interest (e.g., a therapeutic agent (e.g., drug), e.g., a poorly soluble drug, e.g., VX-950). For example, FSD can be performed on a mixture containing VX-950 (e.g., and one or more polymers, and optionally a surfactant(s)) to obtain a solid dispersion of amorphous VX-950, e.g., that can be directly compressed into an oral dosage form (e.g., tablet). Alternatively, the dispersion can be blended with one or more excipients prior to compression.

As discussed, parameters that can be adjusted in the drying process include outlet temperatures in the spray dryer, choice of solvents, choice of gas and its temperature. Further, temperature and number of condensers if in closed cycle spray drying mode, type of atomization (e.g., two-fluid, rotary, or pressure nozzle), direction of flow in relation to atomization inlet (co-current or fountain mode), solids concentration of the feed, flow rate of the drying gas, and/or residence time of the droplet, feed pressure or flow rate of the feed, atomization gas rate (if applicable), type and diameter of cyclone separator, type of membrane baghouse filter can also be adjusted. For example, parameters can be selected to result in a dispersion with one or more of the following properties: median particle size (d50) of 40-500 μm, volumetric particle size distributions with low spans ([d90-d10]/d50), e.g., preferably <3.0 (e.g., at low dispersing pressures), more preferably span <2.0, powder bulk density of between about 0.13 to about 0.45 g/cc, e.g., about 0.13 to about 0.32 g/cc, about 0.25 to about 0.4 g/cc, about 0.33 to about 0.45 g/cc, improved powder flowability (e.g., low cohesion forces, low interparticle internal friction); and/or dry powder with low OVIs. The spray dryer used to prepare the dispersion can also be varied.

The term “physically stable,” as used herein, means that the form of VX-950, does not change into one or more different physical forms of VX-950 (e.g., different solid forms as measured by XRPD, DSC, etc.) when subjected to specified conditions, e.g., room temperature ambient humidity or 40° C./75% relative humidity, for a specified period of time, e.g., 1 day, 2 days, 3 days, 1 week, 2 weeks, 1 month, 2 months, 3 months, 6 months, 12 months, 18 months, 24 months, or longer. In some embodiments, less than 25% of the form of VX-950 changes into one or more different physical forms when subjected to specified conditions, In some embodiments, less than about 20%, less than about 15%, less than about 10%, less than about 5%, less than about 3%, less than about 1%, less than about 0.5% of the form of VX-950 changes into one or more different physical forms of VX-950 when subjected to specified conditions under the conditions specified. In some embodiments, no detectable amount of the form of VX-950 changes into one or more different physical forms of VX-950.

The term “chemically stable,” as used herein, means that the chemical structure of VX-950, does not change into another compound (e.g., decompose) when subjected to specified conditions, e.g., room temperature ambient humidity or 40° C./75% relative humidity, for a specified period of time, e.g., 1 day, 2 days, 3 days, 1 week, 2 weeks, 1 month, 2 months, 3 months, 6 months, 12 months, 18 months, 24 months, or longer. In some embodiments, less than 25% of the form of VX-950 changes into one or more other compounds when subjected to specified conditions, In some embodiments, less than about 20%, less than about 15%, less than about 10%, less than about 5%, less than about 3%, less than about 1%, less than about 0.5% of the form of VX-950 changes into one or more other compounds of VX-950when subjected to specified conditions under the conditions specified. In some embodiments, no detectable amount of the form of VX-950 changes into one or more different physical forms of VX-950.

VX-950 (Telaprevir)

In general, it has been found that absolute bioavailability after orally administering a micronized crystalline drug powder of VX-950 to rats is less than 0.5%. Simple mixtures of VX-950 with conventional pharmaceutical excipients exhibit similarly low bioavailability upon oral administration to mammals. Compositions including VX-950 in crystalline form (i.e., where a significant portion of VX-950 is in crystalline form) generally do not achieve drug absorption to an extent that provides for sufficient therapeutic effects of VX-950. The compositions described herein provide comparatively improved bioavailability. Accordingly, in some embodiments, a method of FSD of a feed solution containing VX-950 is provided. For example, the method can be used to prepare a product that is substantially free of impurities, such as crystalline VX-950. In some embodiments, the disclosure includes a pharmaceutical composition, e.g., comprising a compound, e.g., an agglomerated dispersion of VX-950, or of an agglomerated solid dispersion comprising VX-950 in a directly compressed form. The compositions of this disclosure are stable, easy to administer, and give high bioavailability of VX-950 upon administration.

In certain embodiments, the VX-950 is present in the product in an amount of from about 5% to about 95% by weight, for example from about 20% to about 90%, from about 30% to about 80%, about 40% to about 70%, from about 45% to about 55%, preferably up to about 30% (e.g., 28% to 32%), up to about 35% (e.g., about 33% to 37%), up to about 40% (e.g., about 38% to 42%), up to about 45% (e.g., about 43% to 47%), up to about 50% (e.g., about 48% to 52%), up to about 55% (e.g., 53% to 57%), up to about 60% (e.g., 58% to 62%), up to about 65% (e.g., 63% to 67%), up to about 70% (e.g., 68% to 72%), up to about 75% (e.g., 73% to 77%), up to about 80% (e.g., 78% to 82%), up to about 85% (e.g., 83% to 87%), or up to about 90% (e.g., 88% to 92%) by weight. The VX-950 is a mixture of the D-isomer and L-isomer or is a substantially pure product of either isomer. The VX-950 is preferably substantially amorphous (e.g., at least about 50% of VX-950 is amorphous, at least about 55% of VX-950 is amorphous, at least about 60% of VX-950 is amorphous, at least about 65% of VX-950 is amorphous, at least about 70% of VX-950 is amorphous, at least about 75% of VX-950 is amorphous, at least about 80% of VX-950 is amorphous, at least about 85% of VX-950 is amorphous, at least about 90% of VX-950 is amorphous, at least about 95% of VX-950 is amorphous, at least about 98% of VX-950 is amorphous, at least about 99% of VX-950 is amorphous, or substantially all of VX-950 is amorphous).

As used herein, the term “amorphous” refers to a solid material having no long range order in the position of its atoms. Amorphous solids are generally supercooled liquids in which the molecules are arranged in a random manner so that there is no well-defined arrangement and no long range order. Amorphous solids are generally isotropic, i.e., exhibit similar properties in all directions and do not have definite melting points. For example, an amorphous material is a solid material having no sharp characteristic crystalline peak(s) in its X-ray powder diffraction (XRPD) pattern (i.e., is not crystalline as determined by XRPD). Instead, one or several broad peaks (e.g., halos) appear in its XRPD pattern. Broad peaks are characteristic of an amorphous solid. See, US 2004/0006237 for a comparison of XRPDs of an amorphous material and crystalline material.

As used herein “crystalline solids” refers to compounds or compositions where the structural units are arranged in fixed geometric patterns or lattices, so that crystalline solids have rigid long range order. The units that constitute the crystal structure can be atoms, molecules, or ions. Crystalline solids show definite melting points.

As used herein, a “dispersion” refers to a disperse system in which one substance, the dispersed phase, is distributed, in discrete units, throughout a second substance (the continuous phase or vehicle). The size of the dispersed phase can vary considerably (e.g., colloidal particles of nanometer dimension, to multiple microns in size). In general, the dispersed phases can be solids, liquids, or gases. In the case of a solid dispersion, the dispersed and continuous phases are both solids. In pharmaceutical applications, a solid dispersion can include a crystalline drug (dispersed phase) in an amorphous polymer (continuous phase), or alternatively, an amorphous drug (dispersed phase) in an amorphous polymer (continuous phase). In some embodiments, an amorphous solid dispersion includes the polymer constituting the dispersed phase, and the drug constitutes the continuous phase. In some embodiments, the dispersion (e.g., of amorphous VX-950) is prepared by FSD a feed solution.

The term “amorphous solid dispersion” generally refers to a solid dispersion of two or more components, usually a drug and polymer (or plurality of polymers), but possibly containing other components such as surfactants or other pharmaceutical excipients, where the drug is in the amorphous phase, and the physical stability and/or dissolution and/or solubility of the amorphous drug is enhanced by the other components.

An agglomerated solid dispersion as provided herein is a particularly favorable embodiment of this disclosure. Agglomerated solid dispersions typically include a compound dispersed in an appropriate carrier medium, such as a solid state carrier and can have increased particle size and/or bulk and/or tap densities as compared to dispersions obtained by conventional spray drying. In some embodiments, a carrier according to this disclosure comprises a polymer (e.g., a water-soluble polymer or a partially water-soluble polymer). Preferably, in some embodiments, the carrier comprises a plurality of polymers, preferably, one or more water-soluble polymers or one or more partially water-soluble polymers, or a combination thereof.

An exemplary solid dispersion is a co-precipitate or a co-melt of VX-950 with a polymer or plurality of polymers. A “co-precipitate” is a product after dissolving a drug and a plurality of polymers in a solvent or solvent mixture followed by the removal of the solvent or solvent mixture. The mixture of polymers can be suspended or dissolved in the solvent or solvent mixture. The solvent or solvent mixture can include organic solvents and supercritical fluids. The solvent or solvent mixture can also contain a non volatile solvent, such as glacial acetic acid or water. A “co-melt” is a product after heating a drug and a polymer(s) to melt, optionally in the presence of a solvent or solvent mixture, followed by mixing, removal of at least a portion of the solvent if applicable, and cooling to room temperature at a selected rate. In some cases, the solid dispersions are prepared by adding a solution of a drug and solid polymers followed by mixing and removal of the solvent or solvent mixture. To remove the solvent or solvent mixture, vacuum drying, spray drying, fluidized spray drying, tray drying, lyophilization, and other drying procedures may be applied. FSD is a preferred procedure. Applying any of these methods using appropriate processing parameters, according to this disclosure, would provide VX-950 in an amorphous state in the final solid dispersion product. Upon use of appropriate conditions (e.g., low outlet temperatures in the spray dryer, use of low boiling point solvents, use of heated gas or FSD) that result in a dispersion, e.g., agglomerated product, with desirable properties (e.g., median particle size (d50) of 40-500 μm, powder bulk density of between about 0.13 to about 0.45 g/cc, e.g., about 0.13 to about 0.32 g/cc, about 0.25 to about 0.4 g/cc, about 0.33 to about 0.45 g/cc, improved powder flowability (e.g., low cohesion forces, low interparticle internal friction); and/or dry powder with low OVIs), the dispersion can be directly compressed, e.g., into a dosage form (e.g., tablet).

Direct Compression

The product (e.g., a composition containing a compound of interest (e.g., a drug, e.g., a poorly soluble drug, e.g., VX-950)) obtained by FSD can be directly compressed. For example, an agglomerated drug dispersion obtained by FSD can be directly compressed into an oral dosage form (e.g., tablet). The process of direct compression is a process of applying pressure (e.g., via an upper and a lower punch) to materials held in a die cavity. The events that occur in the process of compression are (1) transitional repacking, (2) deformation at point of contact, (3) fragmentation and/or deformation, (4) bonding, (5) deformation of the solid body, (6) decompression, and (7) ejection. The direct-compression process is influenced by powder characteristics such as flowability, compressibility, and dilution potential.

Prior to compression, the product to be compressed can optionally be blended with one or more excipients. The direct-compression process is also influenced by the properties of the excipients used. An important functionality of direct compression (DC) excipients is their compressibility under pressure, which is predominantly determined by material properties such as surface energy and deformation. Further, physicomechanical properties of excipients that ensure a robust and successful process include good flowability, good binding functionality, good compressibility, low lubricant sensitivity, and good machineability even in high-speed tableting machinery with reduced dwell times. For some applications (e.g., in some embodiments of directly compressed forms of VX-950), an excipient(s) with low or no moisture sensitivity is desirable. In addition, a well-designed particle size distribution (i.e., with low spans, e.g., span =[d90-d10]/d50], e.g., preferably <3.0 (e.g., at low dispersing pressures), more preferably spans <2.0) provides favorable mixing conditions. Compatibility with other excipients or drugs and the ability to carry high amounts of active ingredient are also important.

An excipient can be selected, for example, from one or more of the following classes of excipients: microcrystalline cellulose (MCC), starch, lactose, dicalcium phosphate (DCP), lubricant, and sugar. Examples of excipients include: pregelatinized starch, gelatin, croscarmellose sodium (e.g., AC-DI-SOL®), crospovidone, silicon dioxide (e.g., colloidal silicon dioxide, e.g., Cabosil), DC-mannitol, microcrystalline cellulose (e.g., AVICEL®, e.g., AVICEL® PH113, AVICEL® PH102), dibasic calcium phosphate (e.g., anhydrous dibasic calcium phosphate, e.g., granular anhydrous dibasic calcium phosphate, e.g., A-TAB®), sodium stearyl fumarate, sodium starch glycolate.

Blending, e.g., with one or more excipients, can be performed to achieve uniform blending of materials. Blending of materials can be achieved, e.g., by rotating the materials for about 1, about 2, about 5, about 10, about 15, about 20, about 30, about 40, about 50, or about 60 minutes. As further examples, blending can be performed for about 1 to about 60 minutes; about 1 to about 30 minutes; about 1 to about 15 minutes; about 5 to about 20 minutes; about 5 to about 10 minutes. Preferably, blending is performed for about 2 to about 20 minutes. For example, blending can be performed for about 3, about 7, about 10, about 13, or about 14 minutes. In some embodiments, about 10 minutes of blending is performed. In other embodiments, about 21 minutes of blending is performed. Examples of blenders include bin blenders, twin-shell (V-type) blenders. The blending can be performed, e.g., at a controlled temperature, e.g., USP room temperature (e.g., 21±4° C.). The blending can be performed, e.g., at controlled relative humidity, e.g., at less than about 70%, less than about 60%, or less than about 35% relative humidity, e.g., the blending can be performed at 30±5% relative humidity. In some embodiments (e.g., blending of a solid dispersion of amorphous VX-950), the blending is performed at 21±4° C. and 30±5% relative humidity. Temperature and relative humidity can be selected, e.g., to control conditions for the active ingredient, e.g., drug (e.g., solid dispersion of amorphous VX-950).

The suitability of excipients for the direct compression process can be evaluated using one or more of the following parameters. The excipient can be evaluated, e.g., for moisture content, particle size, density, flow property. Compacted preparations containing an excipient(s) and a drug (e.g., a dispersion of VX-950) (e.g., that have been blended together) can be evaluated for compression. For example, different compaction forces (e.g., from 2.2 kN to 22 kN) can be tested for each material. Each compacted product (e.g., containing a solid dispersion of VX-950 and a test excipient(s)) can be weighed, and its dimensions (diameter and thickness) measured to allow for the calculation of relative density, porosity, and degree of volume reduction. The hardness of the compacted preparation can be measured, and Heckel analysis (allows for the interpretation of the mechanism of bonding), Kawakita analysis (describes the relationship between the degree of volume reduction of the powder column and the applied pressure), and Cooper-Eaten analysis (used to evaluate the stages of volume reduction) can be performed. Further details are described in Zhang et al. (AAPS PharinSciTech. (2003) 4(4):E62). The properties of the compacted product containing a test excipient(s) can optionally be compared to the properties of another compacted product, e.g., a directly compressed form that contains a solid dispersion of VX-950 and no excipient. In addition or alternatively, the amounts of excipient(s) used can be varied and the properties of the resultant compacted product can optionally be compared to another compacted product, e.g., a directly compressed form that contains a solid dispersion of VX-950 and no excipient. In addition or alternatively, combinations of excipients can be tested and evaluated for suitability in a similar manner.

Parameters that can be adjusted in the drying process to obtain a dispersion suitable for direct compression include outlet temperatures in the spray dryer, choice of solvents, choice of gas and its temperature. Further, temperature and number of condensers if in closed cycle spray drying mode, type of atomization (e.g., two-fluid, rotary, or pressure nozzle), direction of flow in relation to atomization inlet (co-current or fountain mode), solids concentration of the feed, flow rate of the drying gas, and/or residence time of the droplet, feed pressure or flow rate of the feed, atomization gas rate (if applicable), type and diameter of cyclone separator, type of membrane baghouse filter can also be adjusted. Parameters can be selected to result in a dispersion with one or more of the following properties: median particle size (d50) of 40-500 μm, volumetric particle size distributions with low spans ([d90-d10]/d50), e.g., preferably <3.0 (e.g., at low dispersing pressures), more preferably span <2.0, powder bulk density of between about 0.13 to about 0.45 g/cc, e.g., about 0.13 to about 0.32 g/cc, about 0.25 to about 0.4 g/cc, about 0.33 to about 0.45 g/cc, improved powder flowability (e.g., low cohesion forces, low interparticle internal friction); and/or dry powder with low OVIs. The spray dryer used to prepare the dispersion can also be varied. The parameters can be adjusted and tested as described herein.

In some embodiments, the directly compressed dosage form includes between about 5% and about 99% of a solid dispersion of VX-950. For example, the directly compressed dosage form is made up of about 10%, about 20%, about 30%, about 40%, about 50%, about 60%, about 70%, about 80%, about 85%, about 90%, about 95%, about 96%, about 97%, about 98% of a solid dispersion of VX-950. The directly compressed dosage form can optionally include another excipient, e.g., the form can include a component from one or more of the following classes of excipients: microcrystalline cellulose (MCC), starch, lactose, dicalcium phosphate (DCP), lubricant, and sugar. Examples of excipients include: pregelatinized starch, gelatin, croscarmellose sodium, crospovidone, silicon dioxide, DC-mannitol, AVICEL®, A-TAB®, sodium stearyl fumarate. The excipient can be present in an amount of between about 0% and about 80%,e.g., between about 1% and about 40%, e.g., each excipient can be present in an amount of between about 1% and about 8%, e.g., at about 7% to about 8%. For example one or more of the following excipients can be blended with a FSD product prior to compaction: MCC and/or DCP can be added to improve flow and compactibility, sodium stearyl can be added as a lubricant (e.g., to help get the compressed product out of the die), silicon dioxide can be added to improve flow, and/or croscarmellose sodium can be added as a disintegrant.

By performing direct compression, advantages in the production process of a pharmaceutical composition (e.g., a compound of interest (e.g., a drug, e.g., a poorly soluble drug, e.g., VX-950)) include one or more of the following: improved downstream processing of the composition (e.g., as compared to a composition obtained by conventional spray drying), including blending with excipients (if needed), tablet hopper flow, continuous tablet die flow, tablet weight uniformity; subtraction of roller compaction, milling steps; driest powder possible incorporated into tablet; less steps for unwanted amorphous to crystalline transfer; continuous operation of tablet presses with very low RSDs in weight uniformity, very low RSDs in respective drug or excipient weight uniformity; possible direct manufacturing system of spray drying, post drying, blending, and tableting and possibly just spray drying and tableting; and improved dissolution in vitro and in vivo.

As used herein, the term “directly compressed dosage form” generally refers to a form (e.g., a tablet) that is obtained by the compression of a dry blend of powders (e.g., solid dispersion, e.g., agglomerated dispersion) that comprise a compound, e.g., an active ingredient, e.g., a therapeutic agent, e.g., a drug (e.g., a poorly soluble drug, e.g., VX-950, e.g., amorphous VX-950, e.g., in a solid dispersion, e.g., that also includes a polymer(s) and optionally a surfactant(s)) and optionally one or more excipients. For example, the product (e.g., solid dispersion) resulting from a process described herein can have improved properties (e.g., flowability) that allow it to be directly compressed, e.g., into an oral dosage form, e.g., tablets, or to be formulated into capsules or saches.

Polymers

Products (e.g., agglomerated products such as powders or granules) of FSD such as solid dispersions (e.g., amorphous solid dispersions) including a compound of interest (e.g., a drug, e.g., a poorly soluble drug, e.g., VX-950) and a polymer or plurality of polymers (or solid state carrier(s)), are provided herein. A polymer or plurality of polymers can be used as part of an amorphous solid dispersion system together with compound of interest. For example, a polymer(s) can be present in a feed solution (e.g., that will be dried by FSD) with a compound of interest (e.g., drug). Without being bound by theory, the presence of a polymer can help prevent, decrease, or slow the amount or rate of crystallization of the compound of interest (e.g., drug) as compared to the amount or rate of crystallization that occurs in the absence of a polymer. For example, when a polymer is used, the amount of crystallization can be decreased by at least about 10%, by at least about 20%, by at least about 30%, by at least about 40%, by at least about 50%, by at least about 60%, by at least about 70%, by at least about 80%, by at least about 90%, by at least about 95%, or by at least about 99% compared to the amount of crystallization in the absence of a polymer. For example, a polymer or plurality of polymers can protect a drug against crystallization in an aqueous medium, such as gastric fluids and/or in intestinal fluids. For example, HPMC can help decrease the amount of crystallization (e.g., of a compound of interest (e.g., a drug, e.g., a poorly soluble drug, e.g., VX-950)) in low pH, such as in gastric fluids. HPMC can provide protection in gastric fluids (e.g., fasted or fed gastric fluids), and simulated gastric fluids (“SGF”) (e.g., fasted or fed SGF). As another example, HPMCAS can provide increased physical 20 stability and decrease the amount of crystallization (e.g., a compound of interest (e.g., a drug, e.g., a poorly soluble drug, e.g., VX-950)) in intestinal fluids (e.g., fasted or fed intestinal fluids) and simulated intestinal fluids (“SIF”) (e.g., fasted or fed SIF). As a result, one or more of bioavailability, solubility and absorption of the compound of interest (e.g., a drug, e.g., a poorly soluble drug, e.g., VX-950) can be enhanced.

In addition, by decreasing the rate of crystallization, a polymer can increase the shelf stability of a composition, e.g., a dispersion obtained by FSD or a solid form (e.g., a directly compressed form, e.g., a tablet), containing a compound of interest (e.g., a drug, e.g., a poorly soluble drug, e.g., VX-950) relative to the stability of the composition when no polymer is used by at least about 10% (e.g., by at least about 20%, by at least about 30%, by at least about 40%, by at least about 50%, by at least about 60%, by at least about 70%, by at least about 80%, or by at least about 90%). The polymer can increase the stability of the solid dispersion (e.g., when stored at 4° C. or at room temperature) by at least about 10% (e.g., by at least about 20%, by at least about 30%, by at least about 40%, by at least about 50%, by at least about 60%, by at least about 70%, by at least about 80%, or by at least about 90%) as compared to a solid dispersion stored under identical conditions and in the absence of a polymer.

Further, without being bound by theory, the presence of a plurality of polymers can help prevent, decrease, or slow the amount or rate of crystallization of the compound of interest (e.g., a drug, e.g., a poorly soluble drug, e.g., VX-950) as compared to the amount or rate of crystallization that occurs in the presence of one polymer. For example, when a plurality of polymers is used, the amount of crystallization can be decreased by at least about 10%, by at least about 20%, by at least about 30%, by at least about 40%, by at least about 50%, by at least about 60%, by at least about 70%, by at least about 80%, by at least about 90%, by at least about 95%, or by at least about 99% compared to the amount of crystallization in the presence of one polymer. For example, a plurality of polymers can protect a drug against crystallization in an aqueous medium, such as gastric fluids or in intestinal fluids. For example, a polymer, e.g., HMPC or HPMCAS, or plurality of polymers, e.g., a mixture comprising HPMC and HPMCAS, can offer increased protection to a given dispersion of VX-950: for example, the HMPC can protect the VX-950 from crystallization in gastric fluids or SGF while the HPMCAS can protect the VX-950 from crystallization in intestinal fluids or in SIF. As a result, use of a mixture can offer improved bioavailability, solubility, and/or absorption of a compound of interest (e.g., a drug, e.g., a poorly soluble drug, e.g., VX-950). In addition, a plurality of polymers can increase the shelf stability of a composition, e.g., a solid form (e.g., a spray dried dispersion, a directly compressed dosage form, e.g., a tablet), containing a compound of interest (e.g., a drug, e.g., a poorly soluble drug, e.g., VX-950) relative to the stability of the composition when no polymer is used by at least about 10% (e.g., by at least about 20%, by at least about 30%, by at least about 40%, by at least about 50%, by at least about 60%, by at least about 70%, by at least about 80%, or by at least about 90%). The plurality of polymers can increase the stability of the solid dispersion (e.g., when stored at 4° C. or at room temperature) by at least about 10% (e.g., by at least about 20%, by at least about 30%, by at least about 40%, by at least about 50%, by at least about 60%, by at least about 70%, by at least about 80%, or by at least about 90%) as compared to a solid dispersion stored under identical conditions and containing no polymer.

The polymer or plurality of polymers (e.g., containing one or more cellulosic polymers) can be used to provide a form of a compound of interest (e.g., a drug, e.g., a poorly soluble drug, e.g., VX-950) such that, when administered, the area under curve (AUC) of the compound of interest (e.g., a drug, e.g., a poorly soluble drug, e.g., VX-950) would be substantially the same in fasted and fed subjects, e.g., reducing or substantially eliminating the food effect in the subject.

In one embodiment, a polymer or plurality of polymers, or one or more of the polymers in a plurality of polymers of the present disclosure are able to dissolve in aqueous media. The solubility of the polymer(s) may be pH-independent or pH-dependent. The latter include one or more enteric polymers. The term “enteric polymer” refers to a polymer that is preferentially soluble in the less acidic environment of the intestine relative to the more acid environment of the stomach, for example, a polymer that is insoluble in acidic aqueous media but soluble when the pH is above 5-6. An appropriate polymer should be chemically and biologically inert. In order to improve the physical stability of the solid dispersions, the glass transition temperature (T_{g}) of the polymer or polymers (e.g., of a plurality of polymers, or one or more of the polymers in a plurality of polymers) should be as high as possible. For example, preferred polymers have a glass transition temperature at least equal to or greater than the glass transition temperature of the compound of interest (e.g., a drug, e.g., a poorly soluble drug, e.g., VX-950). Other preferred polymers have a glass transition temperature that is within about 10 to about 15° C. of the compound of interest (e.g., a drug, e.g., a poorly soluble drug, e.g., VX-950). Examples of suitable glass transition temperatures of the polymers include at least about 55° C., at least about 60° C., at least about 65° C., at least about 70° C., at least about 75° C., at least about 80° C., at least about 85° C., at least about 90° C., at least about 95° C., at least about 100° C., at least about 105° C., at least about 110° C., at least about 115° C., at least about 120° C., at least about 125° C., at least about 130° C., at least about 135° C., at least about 140° C., at least about 145° C., at least about 150° C., at least about 155° C., at least about 160° C., at least about 165° C., at least about 170° C., or at least about 175° C. (as measured under dry conditions). Without wishing to be bound by theory, it is believed that the underlying mechanism is that a polymer with a higher T_{g} generally has lower molecular mobility at room temperature, which can be a crucial factor in stabilizing the physical stability of the amorphous solid dispersion.

Additionally, the hygroscopicity of the polymer (or of a plurality of polymers, or one or more of the polymers in a plurality of polymers) should be as low as possible. For the purpose of comparison in this application, the hygroscopicity of a polymer, combination of polymers, or composition is characterized at about 60% relative humidity. In some preferred embodiments, the polymer(s) has less than about 10% water absorption, for example less than about 9%, less than about 8%, less than about 7%, less than about 6%, less than about 5%, less than about 4%, less than about 3%, or less than about 2% water absorption. Cellulosic polymers generally have about 3% water absorption whereas PVP generally has about 9% water absorption. The hygroscopicity can also affect the physical stability of the solid dispersions. Generally, moisture adsorbed in the polymers can greatly reduce the Tg of the polymers as well as the resulting solid dispersions, which will further reduce the physical stability of the solid dispersions as described above.

In one embodiment, a polymer or plurality of polymers, or one or more of the polymers in a plurality of polymers is one or more water-soluble polymer(s) or partially water-soluble polymer(s). Water-soluble or partially water-soluble polymers include but are not limited to, cellulose derivatives (e.g., hydroxypropylmethylcellulose (HPMC; also known as hypromellose), hydroxypropylcellulose (HPC)) or ethylcellulose; polyvinylpyrrolidones (PVP); polyethylene glycols (PEG); polyvinyl alcohols (PVA); acrylates, such as polymethacrylate (e.g., EUDRAGIT® E); cyclodextrins (e.g., β-cyclodextin) and copolymers and derivatives thereof, including for example PVP-VA (polyvinylpyrollidone-vinyl acetate). In some preferred embodiments, the polymer or one of the plurality of polymers is hydroxypropylmethylcellulose (HPMC), such as HPMC E50 (e.g., from Dow), HPMCE15, or HPMC 60SH 50cP (e.g., Shin-Etsu Metolose, HPMC60SH50). HPMC is available in a variety of types from Shin-Etsu, including SM, 60SH, 65SH, 90SH. Each of these types vary by viscosity grade and methoxyl and hydroxypropoxyl content. A most preferred type for use in the spray dispersion is HPMC 60SH.

In some embodiments, the polymer or plurality of polymers, or one or more of the polymers in a plurality of polymers are a pH-dependent enteric polymer. Such pH-dependent enteric polymers include, but are not limited to, cellulose derivatives (e.g., cellulose acetate phthalate (CAP)), hydroxypropyl methyl cellulose phthalates (HPMCP), hydroxypropyl methyl cellulose acetate succinate (HPMCAS), hydroxypropyl methyl cellulose acetate (HPMCA), carboxymethylcellulose (CMC) or a salt thereof (e.g., a sodium salt such as (CMC—Na)); cellulose acetate trimellitate (CAT), hydroxypropylcellulose acetate phthalate (HPCAP), hydroxypropylmethyl-cellulose acetate phthalate (HPMCAP), and methylcellulose acetate phthalate (MCAP), or polymethacrylates (e.g., EUDRAGIT® S). In some preferred embodiments, the polymer or one of the plurality of polymers is hydroxypropyl methyl cellulose acetate succinate (HPMCAS). HPMCAS is available in a variety of grades from Shin-Etsu, including AS-LF, AS-MF, AS-HF, AS-LG, AS-MG, AS-HG. Each of these grades vary with the percent substitution of acetate and succinate. A most preferred grade for use in the spray dispersion is AS-HG from Shin-Etsu.

Other polymers of HPMCAS and HPMCA with varying degrees and combinations of substitution of hydroxypropoxy, methoxy, acetyl, and succinoyl groups are also known in the art (see e.g., WO 2005/115330), and can be used with the inventions described herein. For example, HPMCAS polymers where the degree of substitution of succinoyl groups (DOSS) and the degree of substitution of acetyl groups (DOS_{Ac}) on the HPMCAS are DOS_{S}≧ about 0.02, DOS_{Ac}≧ about 0.65, and DOS_{Ac}+DOS_{S}≧ about 0.85 can be used. As other examples, HPMCA polymers where the degree of substitution of acetyl groups (DOS_{Ac}) on the polymer is about 0.6 or less, or the degree of substitution of acetyl groups (DOS_{Ac}) on the polymer is at least about 0.15, can be used. In other embodiments, HPMCA polymers having a solubility parameter of about 24.0 (J/cm) or less can be used.

In yet another embodiment, the polymer or one or more of the polymers in a plurality of polymers is an insoluble cross-linked polymer, for example a polyvinylpyrrolidone (e.g., Crospovidone).

In some cases, a polymer may react with a compound of interest. Therefore, in some embodiments, a polymer that does not react with the compound of interest is preferred when preparing a feed solution containing that compound. For example, alcohols may react with the compound of interest (e.g., a drug, e.g., a poorly soluble drug, e.g., VX-950) to form ketals. Accordingly, a polymer that does not react with the compound of interest (e.g., a drug, e.g., a poorly soluble drug, e.g., VX-950) (particularly to form ketals) is preferred when preparing a feed solution containing that compound. Such a polymer should not contain an OH group or a similarly reactive moiety. Because of the reactivity of certain compounds (e.g., VX-950), a preferred polymer for use in a plurality of polymers or as the polymer in connection with this disclosure for the preparation of a feed solution containing such a compound is other than a polyethylene glycol (e.g., PEG 8000) (i.e., other than a polymer having free hydroxyl moieties).

In embodiments where the compound of interest (e.g., a drug, e.g., a poorly soluble drug, e.g., VX-950) forms a solid dispersion (e.g., agglomerated product) with a polymer or plurality of polymers, for example VX-950 with an HPMC and/or an HPMCAS polymer, the total amount of polymer(s) relative to the total weight of the solid dispersion is typically at least about 5% (e.g., about 4% or 6%), at least about 10% (e.g., 9% or 11%), at least about 15% (e.g., 14% or 16%), at least about 20% (e.g., 19% or 21%), and preferably at least about 30% (e.g., about 29% or 31%), for example, at least about 35% (e.g., about 34% or 36%), at least about 40% (e.g., about 39% or 41%), at least about 45% (e.g., about 44% or 46%), or at least about 50% (e.g., about 49% or 51%). The amount is typically about 99% or less, and preferably about 80% or less, for example about 75% or less, about 70% or less, about 65% or less, about 60% or less, or about 55% or less. In one embodiment, the polymer(s) is in an amount of up to about 30% of the total weight of the dispersion (and even more specifically, between about 28% and 32%, such as about 29%). In one embodiment, the polymer(s) is in an amount of up to about 35% of the total weight of the dispersion (and even more specifically, between about 33% and 37%, such as about 34%). In one embodiment, the polymer(s) is in an amount of up to about 40% of the total weight of the dispersion (and even more specifically, between about 38% and 42%, such as about 39%). In one embodiment, the polymer(s) is in an amount of up to about 45% of the total weight of the dispersion (and even more specifically, between about 43% and 47%, such as about 44%).

The solid dispersions (e.g., agglomerated products) containing a compound of interest (e.g., a drug, e.g., a poorly soluble drug, e.g., VX-950) can contain a plurality of polymers. For example, two polymers can be used in the dispersion. In some embodiments, the plurality of polymers can include one or more than one cellulosic polymer. For example, a spray dried dispersion can include two cellulosic polymers, e.g., HPMC and HPMCAS. In some embodiments, the solid dispersion includes a mixture of HPMC and HPMCAS. The amount of each polymer used in the dispersion can vary, and the ratio of the polymers to each other can also vary. For example, the dispersion can include from about 0% to about 100% by weight of a first polymer (e.g., HPMC) and from about 0% to about 100% by weight of a second polymer (e.g., HPMCAS) (wherein the percentages by weight of the two polymers add up to 100% of total polymer present in a dispersion). For example, in a solid dispersion of VX-950 containing polymers, the first polymer is present in an amount of about 33% and the second polymer is present in an amount of about 67% of the total amount of polymer added. In another example, the first polymer is present in an amount of about 55.5% and the second polymer is present in an amount of about 44.5% of the total amount of polymer added. In another example, the first polymer is present in an amount of about 63% and the second polymer is present in an amount of about 37% of the total amount of polymer added. In another example, the first polymer is present in an amount of about 50% and the second polymer is present in an amount of about 50% of the total amount of polymer added. In another example, the first polymer is present in an amount of about 100% and the second polymer is present in an amount of about 0% of the total amount of polymer added.

In one of the more specific embodiments of this disclosure, one of the polymers is polyvinylpyrrolidone (PVP) (e.g., PVP29/32). The PVP can be present in an amount of up to about 35%, up to about 40%, up to about 45%, or up to about 50%. A dispersion comprising about 50% (e.g., about 49.5%) PVP K29/32 is included within this disclosure.

In another embodiment, the disclosure includes a solid dispersion (e.g., agglomerated product) of a compound of interest (e.g., a drug, e.g., a poorly soluble drug, e.g., VX-950) and a cellulosic polymer, for example an HPMC or an HPMCAS polymer. In some preferred embodiments, the compound (i.e., VX-950) is present in an amount of at least about 50% of the dispersion, for example at least about 55%, at least about 60%, at least about 65%, at least about 70%, at least about 75%, at least about 80%, at least about 85%, at least about 90%, or even greater. In some preferred embodiments, the drug is present in an amount between about 55% and about 90%, such as about 55%, about 60%, about 65%, about 70%, about 75%, about 80%, or about 85%. The amount of polymers is present in an amount of at least about 5%, at least about 10%, at least about 15%, and preferably at least about 20%, for example, at least about 25%, at least about 30%, at least about 35%, at least about 40%, or at least about 45%. In some embodiments, the amount is typically about 55% or less, and preferably about 50% or less, for example about 45% or less, about 40% or less, about 35% or less, about 30% or less, about 25% or less, about 20% or less, about 15% or less, or about 10% or less.

In another embodiment, the disclosure includes a solid dispersion (e.g., agglomerated product) of a compound of interest (e.g., a drug, e.g., a poorly soluble drug, e.g., VX-950) and at least two cellulosic polymers, for example an HPMC and/or an HPMCAS polymer. In some preferred embodiments, the compound (i.e., VX-950) is present in an amount of at least about 50% of the dispersion, for example at least about 55%, at least about 60%, at least about 65%, at least about 70%, at least about 75%, at least about 80%, at least about 85%, at least about 90%, or even greater. In some preferred embodiments, the drug is present in an amount between about 55% and about 70%, such as about 55%, about 60%, about 65%, or about 70%. As described above, the total amount of polymers is present in an amount of at least about 15%, and preferably at least about 20%, for example, at least about 25%, at least about 30%, at least about 35%, at least about 40%, or at least about 45%. In some embodiments, the amount is typically about 55% or less, and preferably about 50% or less, for example about 45% or less, about 40% or less, about 35% or less, about 30% or less, about 25% or less, about 20% or less, about 15% or less, or about 10% or less.

In some preferred embodiments, the dispersion further includes other minor ingredients, such as a surfactant (e.g., SLS or Vitamin E TPGS). In some preferred embodiments, the surfactant is present in less than about 10% by weight of the dispersion, for example less than about 9% by weight, less than about 8% by weight, less than about 7% by weight, less than about 6% by weight, less than about 5% by weight, less than about 4% by weight, less than about 3% by weight, less than about 2% by weight, or about 1% by weight.

In a most preferred embodiment, the dispersion includes about 49.5% VX-950, about 49.5% HPMCAS, and about 1% SLS.

The polymer or plurality of polymers should be present in an amount effective for stabilizing the solid dispersion. Stabilizing includes inhibiting or decreasing the crystallization of a compound of interest (e.g., a drug, e.g., a poorly soluble drug, e.g., VX-950). Such stabilizing would inhibit the conversion of the compound from amorphous to crystalline form. For example, the polymer(s) would prevent at least a portion (e.g., about 5%, about 10%, about 15%, about 20%, about 25%, about 30%, about 35%, about 40%, about 45%, about 50%, about 55%, about 60%, about 65%, about 70%, about 75%, or greater) of the compound from going from an amorphous to a crystalline form.

For example, at low pH (e.g., in gastric fluid (e.g., fasted gastric fluid) or SGF (e.g., fasted SGF), a compound of interest (e.g., a drug, e.g., a poorly soluble drug, e.g., VX-950) may dissolve, become supersaturated, and then crystallize. The polymer or plurality of polymers can prevent or decrease the crystallization of the compound in such or similar conditions, or during storage of a composition containing the compound. Stabilization can be measured, for example, by measuring the glass transition temperature of the solid dispersion, measuring the rate of relaxation of the amorphous material, or by measuring the solubility or bioavailability of the compound.

A polymer or plurality of polymers can be used in a formulation with a compound of interest (e.g., a drug, e.g., a poorly soluble drug, e.g., VX-950). One, more than one, or all of the polymers suitable for use in combination with the compound, for example to form a solid dispersion (e.g., agglomerated product) such as an amorphous solid dispersion, should have one or more of the following properties:

1. The glass transition temperature of the polymer or polymers in combination should have a temperature of no less than about 10-15° C. lower than the glass transition temperature of the compound. Preferably, the glass transition temperature of the polymer or polymers in combination is greater than the glass transition temperature of the compound, and in general at least 50° C. higher than the desired storage temperature of the drug product. For example, at least about 100° C., at least about 105° C., at least about 105° C., at least about 110° C., at least about 120° C., at least about 130° C., at least about 140° C., at least about 150° C., at least about 160° C., at least about 160° C., or greater.

2. The polymer or polymers in combination should be relatively non-hygroscopic. For example, the polymers should, when stored under standard conditions, absorb less than about 10% water, for example, less than about 9%, less than about 8%, less than about 7%, less than about 6%, or less than about 5%, less than about 4%, or less than about 3% water. Preferably the polymer or polymers will, when stored under standard conditions, be substantially free of absorbed water.

3. The polymer or polymers in combination should have similar or better solubility in solvents suitable for spray drying processes relative to that of the compound. In preferred embodiments, the polymer or polymers will dissolve in one or more of the same solvents or solvent systems as the compound. It is preferred that the polymer or polymers are soluble in at least one non-hydroxy containing solvent such as methylene chloride, acetone, or a combination thereof.

4. The polymer or polymers in combination, when combined with the compound, for example in a solid dispersion, should increase the solubility of the compound in aqueous and physiologically relative media either relative to the solubility of the compound in the absence of polymers or relative to the solubility of the compound when combined with a reference polymer. For example, the polymer or polymers could increase the solubility of amorphous compound by reducing the amount of amorphous compound that converts to crystalline compound from a solid amorphous dispersion.

5. The polymer or polymers in combination should decrease the relaxation rate of the amorphous substance.

6. The polymer or polymers in combination should increase the physical and/or chemical stability of the compound.

7. The polymer or polymers in combination should improve the manufacturability of the compound.

8. The polymer or polymers in combination should improve one or more of the handling, administration or storage properties of the compound.

9. The polymer or polymers in combination should not interact unfavorably with other pharmaceutical components, for example excipients.

The suitability of candidate polymer(s) (or other component) can be tested using the FSD methods described herein to form a composition containing an amorphous 15 compound. The candidate composition can be compared in terms of stability, resistance to the formation of crystals, or other properties, and compared to a reference preparation, e.g., a preparation described herein, e.g., containing a compound of interest (e.g., a drug, e.g., a poorly soluble drug, e.g., VX-950). For example, a preparation of about 83% amorphous VX-950, about 17% HPMCAS, or crystalline VX-950. E.g., a candidate composition could be tested to determine whether it inhibits the time to onset of solvent mediated crystallization, or the percent conversion at a given time under controlled conditions, by at least 50%, 75%, 100%, or 110% as well as the reference preparation, or a candidate composition could be tested to determine if it has improved bioavailability or solubility of VX-950 relative to crystalline VX-950.

A preferred embodiment of an agglomerated product includes a solid dispersion of a compound of interest (e.g., a drug, e.g., a poorly soluble drug, e.g., VX-950), HPMC, HPMCAS, and a surfactant. For example, the agglomerated product includes a solid dispersion including about 55% of the compound, between about 15% and about 25% (e.g., about 19.6%) of an HPMC polymer, such as HPMC60SH50, between about 20% and about 30% (e.g., about 24.4%) of an HPMCAS polymer, such as HPMCAS-HG, and about 1% of a surfactant, such as SLS.

Another preferred embodiment includes a solid dispersion including between about 80% and about 85% (e.g., 83%) of a compound of interest (e.g., a drug, e.g., a poorly soluble drug, e.g., VX-950), and between about 15% and about 20% (e.g., about 17%) of an HPMCAS polymer, such as HPMCAS-HG. The dispersion optionally can contain about 1% of a surfactant, such as SLS.

Another preferred embodiment includes a solid dispersion including about 55% of a compound of interest (e.g., a drug, e.g., a poorly soluble drug, e.g., VX-950), between about 25% and about 35% (e.g., about 29.3%) of an HPMC polymer, such as HPMC60SH50, between about 10% and about 20% (e.g., about 14.7%) of an HPMCAS polymer, such as HPMCAS-HG, and about 1% of a surfactant, such as SLS.

Another preferred embodiment includes a solid dispersion including about 60% of a compound of interest (e.g., a drug, e.g., a poorly soluble drug, e.g., VX-950), between about 10% and about 20% (e.g., about 14.6%) of an HPMC polymer, such as HPMC60SH50, between about 20% and about 30% (e.g., about 24.4%) of an HPMCAS polymer, such as HPMCAS-HG, and about 1% of a surfactant, such as SLS.

Another preferred embodiment includes a solid dispersion including about 65% of a compound of interest (e.g., a drug, e.g., a poorly soluble drug, e.g., VX-950), between about 12% and about 22% (e.g., about 17%) of an HPMC polymer, such as HPMC60SH50, between about 12% and about 22% (e.g., about 17%) of an HPMCAS polymer, such as HPMCAS-HG, and about 1% of a surfactant, such as SLS.

Another preferred embodiment includes a solid dispersion including about 70% of a compound of interest (e.g., a drug, e.g., a poorly soluble drug, e.g., VX-950), between about 15% and about 25% (e.g., about 19.3%) of an HPMC polymer, such as HPMC60SH50, between about 5% and about 15% (e.g., about 9.7%) of an HPMCAS polymer, such as HPMCAS-HG, and about 1% of a surfactant, such as SLS.

Surfactants

Products (e.g., agglomerated products such as powders or granules) of FSD such as solid dispersions (e.g., amorphous solid dispersions) including a compound of interest (e.g., a drug, e.g., a poorly soluble drug, e.g., VX-950) and, optionally, a polymer or plurality of polymers (or solid state carrier(s)), may include a surfactant. A surfactant or surfactant mixture would generally decrease the interfacial tension between the solid dispersion and an aqueous medium. An appropriate surfactant or surfactant mixture may also enhance aqueous solubility and bioavailability of a compound of interest (e.g., a drug, e.g., a poorly soluble drug, e.g., VX-950) from a solid dispersion. The surfactants for use in connection with the present disclosure include, but are not limited to, sorbitan fatty acid esters (e.g., SPANS®), polyoxyethylene sorbitan fatty acid esters (e.g., TWEENS®), sodium lauryl sulfate (SLS), sodium dodecylbenzene sulfonate (SDBS) dioctyl sodium sulfosuccinate (Docusate), dioxycholic acid sodium salt (DOSS), Sorbitan Monostearate, Sorbitan Tristearate, hexadecyltrimethyl ammonium bromide (HTAB), Sodium N-lauroylsarcosine, Sodium Oleate, Sodium Myristate, Sodium Stearate, Sodium Palmitate, Gelucire 44/14, ethylenediamine tetraacetic acid (EDTA), vitamin E or tocol derivates, such as alpha tocopherol, (e.g., d-alpha tocopherol, d1-alpha tocopherol, tocopherol succinate esters) and tocopheryl esters, such as tocopheryl acetate esters, tocopheryl succinate esters, e.g., Vitamin E d-alpha tocopheryl polyethylene glycol 1000 succinate (TPGS; e.g., Vitamin E TPGS from Eastman), Lecithin, MW 677-692, Glutanic acid monosodium monohydrate, Labrasol, PEG 8 caprylic/capric glycerides, Transcutol, diethylene glycol monoethyl ether, Solutol HS-15, polyethylene glycol/hydroxystearate, Taurocholic Acid, Pluronic F68, Pluronic F108, and Pluronic F127 (or any other polyoxyethylene-polyoxypropylene co-polymers (PLURONICS®) or saturated polyglycolized glycerides (GELUCIRS®)). Specific example of such surfactants that may be used in connection with this disclosure include, but are not limited to, Span 65, Span 25, Tween 20, Capryol 90, Pluronic F108, sodium lauryl sulfate (SLS), Vitamin E TPGS, pluronics and copolymers, phospholipids such as PC (phosphatidylcholine) (e.g., from egg or soy), PIs (phosphatidylinositol), PAs (phosphatidic acid), PEs (phosphatidylethanolamine), PGs (phosphatidylglycerol). The surfactant could also be a lipid or fatty acid such as dipalmitoylphosphocholine (DPPC) or similar lipids (DAPC, DSPC, DPPG, etc.). Such lipids can be obtained synthetically, e.g., from Genzyme or Avanti Polar Lipids. SLS (e.g., Sigma or Fischer) and Vitamin E TPGS are preferred.

The amount of the surfactant (e.g., SLS or Vitamin E TPGS) relative to the total weight of the solid dispersion may be between about 0.1-20%. Preferably, it is from about 1% to about 20%, about 1 to about 15%, about 1 to about 10%, more preferably from about 1% to about 5%, e.g., about 1%, about 2%, about 3%, about 4%, or about 5%.

In certain embodiments, the amount of the surfactant relative to the total weight of the solid dispersion is at least about 0.1%, preferably at least about 0.5%, and more preferably at least about 1% (e.g., about 1%). In these embodiments, the surfactant would be present in an amount of no more than about 20%, and preferably no more than about 15%, about 12%, about 11%, about 10%, about 9%, about 8%, about 7%, about 6%, about 5%, about 4%, about 3%, about 2% or about 1%.

Candidate surfactants (or other components) can be tested for suitability for use in the disclosure in a manner similar to that described for testing polymers.

Solvents

FSD can be performed to dry a feed solution that contains one or more solvents. For example, a compound of interest (e.g., a drug, e.g., a poorly soluble drug, e.g., VX-950) and optionally other components, such as one or more polymers, and/or a surfactant, is dissolved or suspended in a solvent(s), resulting in a feed solution. In preferred processes, the solvent includes a volatile solvent. In some embodiments, the solvent includes a mixture of volatile solvents. In other embodiments, the solvent includes volatile and non-volatile solvents. Preferable solvents include those that can dissolve both the compound of interest (e.g., a drug, e.g., a poorly soluble drug, e.g., VX-950) and the polymer(s) (if used). Further, a solvent may help to dissolve a surfactant, if used. Suitable solvents include, for example, volatile and/or non-volatile solvents.

Examples of volatile solvents include methylene chloride (dichloromethane), acetone, ketones, chloroform, and THF. In a preferred process, the solvent is methylene chloride. In a preferred process, the solvent is a mixture of methylene chloride and acetone. The percent weight ratio of methylene chloride:acetone can be for example, about 100:0, about 90: 10, about 80:20, about 75:25, about 70:30, about 60:40, and is preferably about 80:20 or about 70:30.

The solvent or solvent mixture can also contain a non-volatile or high boiling point solvent. Examples of non-volatile solvents include organic acids such as glacial acetic acid, DMSO, DMF, and water. In some embodiments, the non-volatile solvent has a boiling point of about 100° C. or less, e.g., about 80° C. to about 100° C. In a preferred embodiment, the non-volatile solvent is water. In some instances, the non-volatile solvent (e.g., water) can solubilize a component, e.g., a surfactant (e.g., SLS), that is present in the mixture undergoing fluidized spray drying. In a preferred embodiment, use of the non-volatile solvent (e.g., water) yields a dispersion with a higher bulk density. Descriptions of the use of a non-volatile solvent for spray drying a composition are provided in Provisional App. No. 60/784,275, filed Mar. 20, 2006, titled “Pharmaceutical Compositions;” and in the provisional application filed on Dec. 22, 2006, entitled “Pharmaceutical Compositions,” Provisional App. No. 60/871,692 (Attorney-Docket No. 19079-007P02).

The applicants have found that the addition of a non-volatile solvent, such as glacial acetic acid or water, to the solvent or solvent mixture can result in larger, denser, and more flowable particles. Such particles may be better suited for downstream processes, such as compression, e.g., direct compression, into tablets. The non-volatile solvent can be, e.g., up to about 5%, up to about 10%, or up to about 15% by weight of the solvent mixture. For example, a solvent mixture can contain a percent weight ratio of methylene chloride:acetone:glacial acetic acid of about 67:28:5 or 63:27:10. An exemplary percent weight ratio of methylene chloride to acetone to water is 75:24:1.

In some embodiments, the non-volatile solvent is a component in a solvent mixture. For example, the non-volatile solvent is present as a component in a solvent from about 1% to about 20% by weight (e.g., from about 3% to about 15%, from about 4% to about 12%, or from about 5% to about 10%). In other embodiment, the non-volatile solvent (e.g., water) is present in an amount of between about 0% and about 5%, e.g., about 1%.

In some preferred embodiments, the solvent mixture is a combination of a volatile solvent or combination of solvents such as methylene chloride and acetone with a non-volatile solvent such as water or glacial acetic acid. For example, the solvent mixture comprises from about 40% to about 80% methylene chloride, from about 20% to about 35% acetone, and from about 1% to about 15% glacial acetic acid (e.g., from about 50% to about 70% methylene chloride, from about 25% to about 30% acetone, and from about 3% to about 12% glacial acetic acid). As another example, the solvent mixture comprises from about 40% to about 80% methylene chloride, from about 20% to about 35% acetone, and from about 1% to about 15% water (e.g., from about 50% to about 70% methylene chloride, from about 25% to about 30% acetone, and from about 1% to about 5% water). An exemplary percent weight ratio of methylene chloride to acetone to non-volatile solvent is 75:24:1.

In some embodiments, the solvent mixture comprises glacial acetic acid.

In some embodiments, the solvent mixture comprises a combination of glacial acetic acid with at least one volatile solvent such as acetone and/or methylene chloride (e.g., a mixture of methylene chloride and acetone).

In some embodiments, the solvent mixture comprises water.

In some embodiments, the solvent mixture comprises a combination of water with at least one volatile solvent such as acetone and/or methylene chloride (e.g., a mixture of methylene chloride and acetone).

Although alcoholic solvents could be used in connection with a method of FSD of this disclosure, alcohols may react with certain compounds (e.g., VX-950) to form ketals. Accordingly, a solvent that does not react with such a compound, such as VX-950, (particularly to form ketals) is preferred when preparing a feed solution containing such a compound. Such a solvent should not contain an OH group or a similarly reactive moiety. In these processes, therefore, a preferred solvent is other than an alcohol.

Compositions/Packaging/Use

A pharmaceutical composition comprising a product obtained by FSD of a compound of interest (e.g., a drug, e.g., a poorly soluble drug, e.g., VX-950) is also provided herein. The product of FSD (e.g., agglomerated product, e.g., drug, e.g., VX-950) according to this disclosure may be prepared into a pharmaceutical composition for administering to a patient. Although a product of FSD (e.g., an agglomerated solid dispersion) could be considered a pharmaceutical composition, further processing may be needed prior to administration (for example, the solid dispersion may be further directly compressed into a tablet). All such pharmaceutical compositions, dosage forms (e.g., directly compressed dosage forms), and pharmaceutical formulations would be included within this disclosure. The formulations may be prepared using known components according to known methods (see, Handbook of Pharmaceutical Excipients). As would be appreciated, oral formulations are often preferred for pharmaceutical administration.

Accordingly, a pharmaceutical composition comprising a compound of interest (e.g., a drug, e.g., a poorly soluble drug, e.g., VX-950) prepared by a method that includes FSD is provided herein (e.g., the pharmaceutical composition in a directly compressed dosage form). Such compositions typically contain a pharmaceutically acceptable carrier, diluent, or vehicle. In some embodiments, the compound of interest (e.g., a drug, e.g., a poorly soluble drug, e.g., VX-950) is in amorphous form. In some embodiments, the compound of interest (e.g., a drug, e.g., a poorly soluble drug, e.g., VX-950) is in the form of a solid dispersion (e.g., an amorphous solid dispersion). These forms and dispersions are preferably prepared as disclosed herein.

The compositions and processes of this disclosure may optionally include one or more excipients (see U.S. Pat. No. 6,720,003, US 2004/0030151, and/or WO 99/02542)). An excipient is a substance used as a carrier or vehicle in a dosage form, or added to a pharmaceutical composition, to improve handling, storage, or preparation of a dosage form. Excipients include, but are not limited to, diluents, disintegrants, adhesives, wetting agents, lubricants, glidants, crystallization inhibitors, surface modifying agents, agents to mask or counteract a disagreeable taste or odor, flavors, dyes, fragrances, fillers, binders, stabilizers and substances to improve the appearance of a composition. E.g., the excipient(s) can be blended with a solid dispersion of a compound of interest (e.g., a drug, e.g., a poorly soluble drug, e.g., VX-950) and then directly compressed into a dosage form without the need for any further processing steps (e.g., roller compaction and/or milling steps).

Processes for preparing a formulation comprising a compound of interest (e.g., a drug, e.g., a poorly soluble drug, e.g., VX-950) prepared by FSD, or a dispersion or composition thereof, into a dosage form suitable for administration to a mammal are also included herein. Preferably, the formulation comprises a directly compressed dosage form of a compound of interest (e.g., a drug, e.g., a poorly soluble drug, e.g., VX-950) prepared as described herein.

Accordingly, another embodiment of this disclosure provides a composition (e.g., directly compressed dosage form, e.g., tablet) comprising a compound of interest (e.g., a drug, e.g., a poorly soluble drug, e.g., VX-950) prepared by FSD, or a pharmaceutically acceptable salt thereof. According to a preferred embodiment, VX-950 is present in an amount effective to decrease the viral load in a sample or in a patient (e.g., decrease the plasma level of the virus at least about 3 log, at least about 4 log, or at least about 5 log), and optionally, a pharmaceutically acceptable carrier. Alternatively, a composition of this disclosure comprises another additional agent as described herein (e.g., a CYP inhibitor). Each component may be present in individual compositions, combination compositions, or in a single composition. For example, another additional agent may be directly compressed with a solid dispersion of a compound of interest (e.g., a drug, e.g., a poorly soluble drug, e.g., VX-950) into a directly compressed form, e.g., tablet. Alternatively, another additional agent may be separately formulated.

As used herein the term “comprising” is intended to be open-ended, thus indicating the potential inclusion of other agents in addition to the specified agents.

As used herein, the compounds of this disclosure, including VX-950, are defined to include pharmaceutically acceptable derivatives or prodrugs thereof. A “pharmaceutically acceptable derivative or prodrug” means any pharmaceutically acceptable salt, ester, salt of an ester, or other derivative of a compound of this disclosure (for example, an imidate ester of an amide), which, upon administration to a recipient, is capable of providing (directly or indirectly) a compound of this disclosure. Particularly favored derivatives and prodrugs are those that increase the bioavailability of the compounds of this disclosure when such compounds are administered to a mammal (e.g., by allowing an orally administered compound to be more readily absorbed into the blood) or which enhance delivery of the parent compound to a biological compartment (e.g., the liver, brain or lymphatic system) relative to the parent species. Preferred prodrugs include derivatives where a group which enhances aqueous solubility or active transport through the gut membrane is appended to the structure of formulae described herein.

The compound of interest (e.g., a drug, e.g., a poorly soluble drug, e.g., VX-950) utilized in the compositions and methods of this disclosure may also be modified by appending appropriate functionalities to enhance selective biological properties. Such modifications are known in the art and include those which increase biological penetration into a given biological system (e.g., blood, lymphatic system, central nervous system), increase oral availability, increase solubility to allow administration by injection, alter metabolism and alter rate of excretion.

Pharmaceutically acceptable carriers that may be used in these compositions include, but are not limited to, ion exchangers, alumina, aluminum stearate, lecithin, serum proteins, such as human serum albumin, buffer substances such as phosphates, glycine, sorbic acid, potassium sorbate, partial glyceride mixtures of saturated vegetable fatty acids, water, salts or electrolytes, such as protamine sulfate, disodium hydrogen phosphate, potassium hydrogen phosphate, sodium chloride, zinc salts, colloidal silica, magnesium trisilicate, polyvinyl pyrrolidone, cellulose based substances, polyethylene glycol, sodium carboxymethylcellulose, polyacrylates, waxes, polyethylene polyoxypropylene block polymers, polyethylene glycol and wool fat.

The pharmaceutical compositions of this disclosure may be orally administered in any orally acceptable dosage form including, but not limited to, capsules, tablets, pills, powders, granules, aqueous suspensions or solutions. In the case of tablets for oral use, carriers that are commonly used include lactose, microcrystalline cellulose, mannitol, dicalcium phosphate, calcium carbonate and corn starch. Lubricating agents, such as magnesium stearate, sodium stearyl fumerate, or stearic acid, are also typically added. Other ingredients may include disintegrants, such as crosscarmellose sodium or sodium starch glycolate, flow aids such as colloidal silica, and surfactants, such as SLS and Vitamin E, may be included. For oral administration in a capsule form, useful diluents include lactose, microcrystalline cellulose, mannitol, dicalcium phosphate, calcium carbonate and dried cornstarch. Similar to the tablet formulations described above, capsule formulations may also contain lubricants, disintegrants, surfactants, or flow aids. In some embodiments a tablet is coated with a film, e.g., to increase ease of swallowing. When aqueous suspensions are required for oral use, the active ingredient is combined with emulsifying and suspending agents. If desired, certain sweetening, flavoring or coloring agents may also be added. Acceptable liquid dosage forms include emulsions, solutions, suspensions, syrups, and elixirs.

According to a preferred embodiment, the pharmaceutical compositions of this disclosure are formulated for pharmaceutical administration to a mammal, preferably a human being. Although the forms of a compound of interest (e.g., a drug, e.g., a poorly soluble drug, e.g., VX-950) and the dispersions provided herein are preferably formulated for oral administration, other formulations could be obtained.

Other pharmaceutical compositions of the present disclosure (as well as compositions for use in methods, combinations, kits, and packs of this disclosure) may be administered orally, parenterally, sublingually, by inhalation spray, topically, rectally, nasally, buccally, vaginally or via an implanted reservoir. The term “parenteral” as used herein includes subcutaneous, intravenous, intramuscular, intra articular, intra synovial, intrasternal, intrathecal, intrahepatic, intralesional and intracranial injection or infusion techniques. Preferably, the compositions are administered orally or intravenously.

The disclosure also provides pharmaceutical packs and kits comprising a compound of interest (e.g., a drug, e.g., a poorly soluble drug, e.g., VX-950, e.g., amorphous VX-950), a solid dispersion, or a pharmaceutical composition that was obtained by FSD (or contains a component obtained by FSD) according to any of the embodiments herein.

The disclosure further provides methods for treating or preventing hepatitis C virus infection in a patient comprising administering to the patient a pharmaceutical composition. The pharmaceutical composition comprises any form of VX-950 prepared by FSD, any solid dispersion, any directly compressed dosage form, or any composition according to this disclosure.

According to another embodiment, the disclosure provides a method for treating a patient infected with a virus, e.g., an HCV, characterized by a virally encoded NS3/4A serine protease that is necessary for the life cycle of the virus, by administering to said patient any form of VX-950, any solid dispersion, any directly compressed dosage form, or a composition according to this disclosure. Preferably, methods of this disclosure are used to treat a patient suffering from a HCV infection. Such treatment may completely eradicate the viral infection or reduce the severity thereof. More preferably, the patient is a human being.

Pharmaceutical compositions may also be prescribed to the patient in “patient packs” containing more than one dose, and preferably the whole course of treatment, in a single package, (e.g., a blister pack). Patient packs have an advantage over traditional prescriptions, where a pharmacist divides a patient's supply of a pharmaceutical from a bulk supply, in that the patient always has access to the package insert contained in the patient pack, normally missing in traditional prescriptions. The inclusion of a package insert has been shown to improve patient compliance with the physician's instructions. Preferably the drug is in a directly compressed form, e.g., an oral dosage form, e.g., a tablet.

It will be understood that the administration of the combination of the disclosure by means of a single patient pack, or patient packs of each formulation, containing within a package insert instructing the patient to the correct use of the disclosure is a desirable additional feature of this disclosure.

A further aspect of the disclosure is a pack comprising at least any form of a compound of interest (e.g., a drug, e.g., a poorly soluble drug, e.g., VX-950), any solid dispersion, any directly compressed dosage form, or any composition according to this disclosure and an information insert containing directions on the use of the combination of the disclosure. In an alternative embodiment of this disclosure, the pharmaceutical pack further comprises one or more of additional agents as described herein. The additional agent or agents may be provided in the same pack or in separate packs.

Another aspect of this involves a packaged kit for inhibiting HCV, or for a patient to use in the treatment of HCV infection or in the prevention of HCV infection, comprising: a single or a plurality of pharmaceutical formulation of each pharmaceutical component; a container housing the pharmaceutical formulation(s) during storage and prior to administration; and instructions for carrying out drug administration in a manner effective to treat or prevent HCV infection. Preferably, the drug is in a directly compressed form, e.g., an oral dosage form.

Accordingly, this disclosure provides kits for the simultaneous or sequential administration of a compound of interest (e.g., a drug, e.g., a poorly soluble drug, e.g., VX-950) (and optionally an additional agent) or derivatives thereof that are prepared in a conventional manner. Typically, such a kit will comprise, e.g., a composition of each inhibitor and optionally the additional agent(s) in a pharmaceutically acceptable carrier (and in one or in a plurality of pharmaceutical formulations) and written instructions for the simultaneous or sequential administration. Preferably the drug is in an oral dosage form, for example, in a directly compressed dosage form, e.g., a tablet.

In another embodiment, a packaged kit is provided that contains one or more dosage forms (preferably an oral dosage form, e.g., a directly compressed dosage form, e.g., a tableted form) for self administration; a container means, preferably sealed, for housing the dosage forms during storage and prior to use; and instructions for a patient to carry out drug administration. The instructions will typically be written instructions on a package insert, a label, and/or on other components of the kit, and the dosage form or forms are as described herein. Each dosage form may be individually housed, as in a sheet of a metal foil-plastic laminate with each dosage form isolated from the others in individual cells or bubbles, or the dosage forms may be housed in a single container, as in a plastic bottle or a vial. The present kits will also typically include means for packaging the individual kit components, i.e., the dosage forms, the container means, and the written instructions for use. Such packaging means may take the form of a cardboard or paper box, a plastic or foil pouch, etc.

Embodiments of this disclosure may also involve additional agents. Therefore, a method of this disclosure may involve steps as administering such additional agents.

Dosage

Dosage levels of from about 0.01 to about 100 mg/kg body weight per day, preferably from about 10 to about 100 mg/kg body weight per day of VX-950 are useful for the prevention and treatment of HCV mediated disease. In some embodiments, dosage levels are from about 0.4 to about 10 g/day, for example from about 1 to about 4 g/day, preferably from about 2 to about 3.5 g/day, per person (based on the average size of a person calculated at about 70 kg) are included. Typically, the pharmaceutical compositions of, and according to, this invention will be administered from about 1 to about 5 times per day, preferably from about 1 to about 3 times per day, or alternatively, as a continuous infusion. In some embodiments, VX-950 is administered using a controlled release formulation. In some embodiments, this can help to provide relatively stable blood levels of VX-950.

In some embodiments, the dose of amorphous VX-950 (e.g., obtained by FSD) can be a standard dose, e.g., about 1 g to about 5 g a day, more preferably about 2 g to about 4 g a day, more preferably about 2 g to about 3 g a day, e.g., about 2.25 g or about 2.5 g a day. For example, a dose of about 2.25 g/day of amorphous VX-950 can be administered to a patient, e.g., about 750 mg administered three times a day. Such a dose can be administered, e.g., as three 250 mg doses three times a day or as two 375 mg doses three times a day. In some embodiments, the 250 mg dose is in an about 700 mg tablet. In some embodiments, the 375 mg dose is in an about 800 mg tablet. As another example, a dose of about 2.5 g/day of amorphous VX-950 can be administered to a patient, e.g., about 1250 mg administered two times a day. As another example, about 1 g to about 2 g of amorphous VX-950 a day can be administered to a patient, e.g., about 1.35 g of amorphous VX-950 can be administered to a patient, e.g., about 450 mg administered three times a day. The dose of amorphous VX-950 can be administered e.g., as a product of FSD or as a tablet (e.g., a tablet that comprises VX-950, e.g., in a dispersion obtained by FSD). The tablet can be, e.g., a directly compressed dosage form of amorphous VX-950, e.g., as described herein.

In some embodiments, the product of FSD described herein contains at least about 50%, at least about 55%, at least about 60%, at least about 65%, at least about 70%, at least about 75%, at least about 80%, at least about 85% or greater of VX-950 (e.g., amorphous VX-950). Because these FSD products can include greater amounts of VX-950 for a given amount of product (e.g., a greater percent by weight of VX-950), for the same amount by weight of solid dispersion, a greater amount of VX-950 can be incorporated into a pharmaceutical composition (e.g., a directly compressed dosage form), thereby increasing the load of the active ingredient in that composition. As a result, a subject receiving VX-950 can take fewer doses of VX-950 and yet intake the same amount of drug. For example, to receive a dose of 750 mg of VX-950, a subject can take two 375 mg doses of VX-950 containing a solid dispersion described herein instead of three 250 mg doses. This can be an improvement or a preferred dose for some patients. As another example, the increased load of amorphous VX-950 in a FSD product can allow administration of a larger dose of VX-950 to a subject in a fixed total dose of a pharmaceutical composition (e.g., a tablet of a standard size may contain a larger percentage (and thereby dose) of amorphous VX-950). Conversely, the increased load of amorphous VX-950 can allow a fixed dose amount of amorphous to be administered to a subject in a small total dose of a pharmaceutical composition (e.g., a standard dose of amorphous VX-950 can be administered in a smaller tablet).

In some embodiments, the amorphous VX-950 is not 100% potent or pure (e.g., the potency or purity is at least about 90%, at least about 92%, at least about 93%, at least about 94%, at least about 95%, at least about 96%, at least about 97%, at least about 98%, or at least about 99% potent), in which case the doses described above refer to the amount of potent or pure VX-950 administered to a patient rather than the total amount of VX-950. These doses can be administered to a patient as a monotherapy and/or as part of a combination therapy, e.g., as described further below.

Such administration can be used as a chronic or acute therapy. The amount of active ingredient that may be combined with the carrier materials to produce a single dosage form will vary depending upon the subject treated and the particular mode of administration. A typical preparation will contain from about 5% to about 95% active compound (w/w). Preferably, such preparations contain from about 20% to about 80%, from about 25% to about 70%, from about 30% to about 60% active compound.

When the compositions or methods of this disclosure involve a combination of VX-950 and one or more additional therapeutic or prophylactic agents, both the compound and the additional agent should be present at dosage levels of between about 10 to 100%, and more preferably between about 10 to 80% of the dosage normally administered in a monotherapy regimen.

Upon improvement of a patient's condition, a maintenance dose of a compound, composition or combination of this disclosure may be administered, if necessary. Subsequently, the dosage or frequency of administration, or both, may be reduced, e.g., to about ½ or ¼ or less of the dosage or frequency of administration, as a function of the symptoms, to a level at which the improved condition is retained when the symptoms have been alleviated to the desired level, treatment should cease. Patients may, however, require intermittent treatment on a long-term basis upon any recurrence of disease symptoms.

It should also be understood that a specific dosage and treatment regimen for any particular patient will depend upon a variety of factors, including the activity of the specific compound employed, the age, body weight, general health, sex, diet, time of administration, rate of excretion, drug combination, and the judgment of the treating physician and the severity of the particular disease being treated. The amount of active ingredients will also depend upon the particular described compound and the presence or absence and the nature of the additional anti-viral agent in the composition.

Combination Therapy

Methods of this disclosure may also involve administration of another component comprising an additional agent selected from an immunomodulatory agent; an antiviral agent; an inhibitor of HCV protease; an inhibitor of another target in the HCV life cycle; an inhibitor of internal ribosome entry, a broad-spectrum viral inhibitor; another cytochrome P-450 inhibitor; or combinations thereof.

Accordingly, in another embodiment, this invention provides a method comprising administering any form of VX-950, any solid dispersion, any directly compressed dosage form, or any composition according to this disclosure that was obtained by FSD (or contains a component obtained by FSD), a CYP inhibitor, and another anti-viral agent, preferably an anti-HCV agent. Such anti-viral agents include, but are not limited to, immunomodulatory agents, such as α-, β-, and γ-interferons, pegylated derivatized interferon-α compounds, and thymosin; other anti-viral agents, such as ribavirin, amantadine, and telbivudine; other inhibitors of hepatitis C proteases (NS2-NS3 inhibitors and NS3/NS4A inhibitors); inhibitors of other targets in the HCV life cycle, including helicase, polymerase, and metalloprotease inhibitors; inhibitors of internal ribosome entry; broad-spectrum viral inhibitors, such as IMPDH inhibitors (e.g., compounds of U.S. Pat. Nos. 5,807,876, 6,498,178, 6,344,465, 6,054,472; International Applications WO 97/40028, WO 98/40381, WO 00/56331, and mycophenolic acid and derivatives thereof, and including, but not limited to VX-497, VX-148, and/or VX-944); or combinations of any of the above.

A preferred combination therapy comprises a dose of amorphous VX-950 described herein and interferon-α, e.g., pegylated derivatized interferon-α (e.g., pegylated interferon-alpha-2a; e.g., PEGASYS®, e.g., at its standard dose, or pegylated interferon-alpha-2b, e.g., PEG-INTRON® (e.g., REDIPEN PEG-INTRON®), e.g., at its standard dose). For example, a dose (e.g., as described above) of amorphous VX-950, e.g., about 2 g to about 3 g (e.g., 2.5 g, 2.25 g (e.g., 750 mg three times a day)), e.g., in the form described herein (e.g., directly compressed dosage form) can be administered three times a day and pegylated interferon-alpha-2a can be administered at a standard dose, e.g., 180 μg once weekly by subcutaneous administration, e.g., for 48 weeks. As another example, a dose of VX-950 can be administered with both pegylated interferon-alpha-2 and ribavirin. For example, about 2 g to about 3 g (e.g., about 2.5 g, about 2.25 g (e.g., 750 mg three times a day)) of amorphous VX-950 described herein, can be administered three times a day in combination with 180 μg of pegylated interferon-alpha-2a (e.g., PEGASYS®) once a week and ribavirin (e.g., COPEGUS®, REBETOL®) at 1000-1200 mg/day, e.g., for 48 weeks, for genotype 1 patients, or in combination with 180 μg of pegylated interferon-alpha-2a once a week plus ribavirin at 800 mg/day for patients with genotype 2 or 3 hepatitis C.

Each agent may be formulated in separate dosage forms. Alternatively, to decrease the number of dosage forms administered to a patient, each agent may be formulated together in any combination. For example, the VX-950 may be formulated in one dosage form and any additional agents may be formulated together or in another dosage form. VX-950 can be dosed, for example, before, after or during the dosage of the additional agent.

A method according to this disclosure may also comprise the step of administering a cytochrome P450 monooxygenase inhibitor. CYP inhibitors may be useful in increasing liver concentrations and/or increasing blood levels of compounds (e.g., VX-950) that are inhibited by CYP.

The advantages of improving the pharmacokinetics of a drug (e.g., by administering a CYP inhibitor) are well accepted in the art. By administering a CYP inhibitor, this disclosure provides for decreased metabolism of the protease inhibitor, VX-950. The pharmacokinetics of the protease inhibitor are thereby improved. The advantages of improving the pharmacokinetics of a drug are well accepted in the art. Such improvement may lead to increased blood levels of the protease inhibitor. More importantly for HCV therapies, the improvement may lead to increased concentrations of the protease inhibitor in the liver.

In a method of this disclosure, the amount of CYP inhibitor administered is sufficient to increase the blood levels of the VX-950 as compared to the blood levels of this protease inhibitor in the absence of a CYP inhibitor. Advantageously, in a method of this disclosure, an even further lower dose of protease inhibitor may therefore be used (relative to administration of a protease inhibitor alone).

Accordingly, another embodiment of this disclosure provides a method for increasing blood levels or increasing liver concentrations of VX-950 in a patient receiving VX-950 comprising administering to the patient a therapeutically effective amount of VX-950 and a cytochrome P450 monooxygenase inhibitor.

In addition to treating patients infected with hepatitis C, the methods of this disclosure may be used to prevent a patient from becoming infected with hepatitis C. Accordingly, one embodiment of this disclosure provides a method for preventing a hepatitis C virus infection in a patient comprising administering to the patient a) any form of VX-950, any solid dispersion, or any composition according to this disclosure; and b) a cytochrome P450 monooxygenase inhibitor.

As would be realized by skilled practitioners, if a method of this disclosure is being used to treat a patient prophylactically, and that patient becomes infected with hepatitis C virus, the method may then treat the infection. Therefore, one embodiment of this disclosure provides any form of VX-950, any solid dispersion, any directly compressed dosage form, or any composition according to this disclosure and a cytochrome P450 monooxygenase inhibitor wherein the combination of inhibitors are in therapeutically effective amounts for treating or preventing a hepatitis C infection in a patient.

If an embodiment of this disclosure involves a CYP inhibitor, any CYP inhibitor that improves the pharmacokinetics of VX-950 may be used in a method of this disclosure. These CYP inhibitors include, but are not limited to, ritonavir (International Application WO 94/14436), ketoconazole, troleandomycin, 4-methyl pyrazole, cyclosporin, clomethiazole, cimetidine, itraconazole, fluconazole, miconazole, fluvoxamine, fluoxetine, nefazodone, sertraline, indinavir, nelfinavir, amprenavir, fosamprenavir, saquinavir, lopinavir, delavirdine, erythromycin, VX-944 and VX-497. Preferred CYP inhibitors include ritonavir, ketoconazole, troleandomycin, 4-methyl pyrazole, cyclosporin, and clomethiazole. For preferred dosage forms of ritonavir, see U.S. Pat. No. 6,037,157, and the documents cited therein: U.S. Pat. No. 5,484,801, U.S. application Ser. No. 08/402,690, and International Applications WO 95/07696 and WO 95/09614).

The structure of VX-944 is provided below.

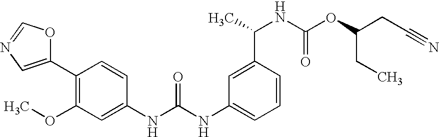

VX-497 is an IMPDH inhibitor. A combination of VX-497, pegylated IFN-α, and ribavirin is currently in clinical development for treating HCV [W. Markland et al., Antimicrobial & Antiviral Chemotherapy, 44, p. 859 (2000); U.S. Pat. No. 6,541,496].

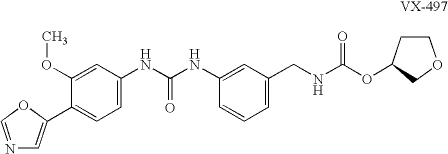

Methods for measuring the ability of a compound to inhibit cytochrome P50 monooxygenase activity are known (see U.S. Pat. No. 6,037,157 and Yun, et al. Drug Metabolism & Disposition, vol. 21, pp. 403-407 (1993).

A CYP inhibitor employed in this disclosure may be an inhibitor of only one isozyme or more than one isozyme. If the CYP inhibitor inhibits more than one isozyme, the inhibitor may nevertheless inhibit one isozyme more selectively than another isozyme. Any such CYP inhibitors may be used in a method of this disclosure.

In a method of this disclosure, the CYP inhibitor may be administered together with any form of VX-950, any solid dispersion, any directly compressed dosage form, or any composition according to this disclosure in the same dosage form or in separate dosage forms.

If the CYP inhibitor and the other components of the combination are administered in separate dosage forms, each inhibitor may be administered about simultaneously. Alternatively, the CYP inhibitor may be administered in any time period around administration of the combination. That is, the CYP inhibitor may be administered prior to, together with, or following each component of the combination.

The time period of administration should be such that the CYP inhibitor affects the metabolism of a component of the combination, preferably, of VX-950. For example, if VX-950 is administered first, the CYP inhibitor should be administered before VX-950 is substantially metabolized and/or excreted (e.g., within the half-life of VX-950).

### Examples

### Example 1

The following example details a process of fluidized spray drying (FSD) and provides the results of fluidized spray drying two mixtures, a mixture of HPMCAS polymer and solvents (placebo) and a mixture of VX-950, HPMCAS, and solvents (active). By varying parameters of the FSD process, the properties of the resulting product can be optimized and tailored for subsequent processing or use.

Objectives

The examples presented herein were designed in part:
i) To describe spray drying studies carried out on a VX-950 dispersion using a commercial spray dryer operating in Fluidized Spray Dryer mode (for example, a dryer with a capacity of 1250 kg/hr operating in FSD mode)
ii) To report the effect of variations in selected operating parameters on product density, particle size distribution, and residual solvents.

Introduction

Increased particle size and/or product density are advantageous to obtaining a direct compressible product. A commercial scale spray dryer (for example, a spray dryer with a capacity of 1250 kg/hr) configured as a Fluidized Spray Dryer (FSD mode) to obtain larger particles and product with a suitably high density, e.g., for direct compression, was used. To accomplish a direct compressible material, it is sometimes desirable to increase the average particle size from the range of 20-40 μm to higher levels, while maintaining or increasing product density (e.g., bulk density >0.2 g/ml and tap density >0.4 g/ml). An additional criterion is to be able to reduce the level of residual solvents, after post-drying, to within acceptable limits.

The analytical work on the spray dried material and final product involved the analysis of particle properties (product density and particle size distribution) and the level of residual solvents.

### Equipment, Materials, and Methods

Two feeds were prepared during the current study. The placebo feed for the high drug formula (placebo) and the respective high drug load formula (active). Table 1 summarizes the feeds spray dried in each experiment.

TABLE 1
Correspondence between feeds, batches, formula and amounts of solids
and solvents used.

| | | Feed 1 | Feed 2 |
|---|---|---|---|
| Formula | | placebo | active |
| VX-950 | kg | — | 25 |
| HPMCAS | kg | 80 | 5 |
| TOTAL SOLIDS | kg | 80 | 30 |
| DCM | kg | 1920 | 120 |
| TOTAL SOLVENTS | kg | 1920 | 120 |
| C_feed | % w/w | 4.0 | 20.0 |

Composition of the solid dispersion (% w/w)

| | | |
|---|---|---|
| VX-950 | — | 83.3 |
| HPMCAS | 100 | 16.6 |

Composition of the solvent (% w/w)

| | | |
|---|---|---|
| DCM | 100 | 100 |

The feeds were prepared in an 8000-L stainless steel stir tank reactor equipped with a mechanical stirrer and thermal circuit for controlling the temperature of the feed. During the preparation of the placebo batch, the solvent was charged to the reactor before charging the polymer (HPMCAS). Complete dissolution was observed under low to moderate stirring (between 30 and 80 rpm). In the active tests, the solids were charged first and thereafter the solvent. Dissolution took about 6 hours. The temperature of the solutions in the feed reactor was kept at about 20° C. (between 15 and 30° C.) while waiting to be fed to the spray drier.

Fluidized Spray Drying of Placebo Feed and Active Feed

A stainless steel commercial scale spray dryer (NIRO, size 4) equipped with a pressure nozzle atomization system was used in the tests. The atomization nozzle used was from Spraying Systems (MFP (Maximum Free Passage) SK Series SPRAYDRY® Nozzles Series variety, orifice 52 with core 27).

A simplified scheme of the spray drying equipment is shown in FIG. 1.

With reference to FIG. 1, the spray drying unit was operated in closed cycle mode, i.e., with recirculation of the drying gas. The spray drying unit included a supply tank containing a solvent (T510) for use during start-up and shut-down operations, and a supply tank containing the material to be dried (R240). To start the spray drying process, valve V2 was opened and the material to be spray dried was fed from the supply tank R240 to the spray drying chamber DC via pump HP-P. The material was partially dried in the drying chamber and then the lighter dried particles exited to the cyclone C with the drying gas, while the heavier particles fell down into fluidized bed FB1. From FB1, the particles eventually circulated to secondary fluidized beds FB2 and FB3 to complete their cooling and drying. The light particles (fines) that went out to cyclone C were then separated out by the cyclone and returned to the drying chamber at the fines return FR. Any tiny particles that passed through the cyclone were caught by the filter bag FB prior to the gas recycling unit RU.

Recirculation of the drying gas was accomplished by recirculating the gas from the recycling unit through one or the other of the closed loops indicated by flow paths (1) and (2). The path taken by the gas exiting the recycling unit was determined by valving (not shown). The gas was recycled through flow path (2) to carry fines from the cyclone back to the drying chamber DC. The gas was also re-circulated to the drying chamber, as drying gas for the drying chamber DC, through a heat exchanger HX1.

The flow of drying nitrogen, controlled by a set-point in the blowing fan (F1), was adjusted to obtain a pressure drop across the cyclone (AP_cyclone) between 10 and 18 cm H₂O. A high pressure pump was used (HP-P), and the feed pressure (P-feed) was controlled automatically by imposing the desired set-point value (P_feed_SP). The fines return position (FR position) was either set to the top of the drying chamber (to promote agglomeration) or to the middle of the drying chamber (to decrease agglomeration). When the valve to closed loop (1) was open, gas was fed to the fluidized chambers FB1-FB3 by an independent fan (VT-FB) and the temperature of each of the three fluidizing chambers (T_FB1, T_FB2, T_FB3) was controlled by three heat-exchangers (HE1, HE2, HE3). These were set to the test values (30, 35, and 40° C., respectively).

The feed was atomized at the nozzle's tip and was dried in the drying chamber by the co-current hot nitrogen. The stream containing the dried product inverted direction within the drying chamber, exiting at the top before entering the cyclone, where most of the solids were separated and the fines were re-introduced into the drying chamber either at the top (to be mixed with the spray formed at the nozzle) or axially to the middle of the drying chamber. As discussed above, the heavier particles formed during drying and/or during the agglomeration process fell down within the drying chamber and into the main fluidizing chamber (FB1). The process proceeded until a given layer of product (measured as a differential pressure across FB1) was obtained. Part of the product in FB1 was then discharged to FB2 where a post-drying process occurred, after which the product in FB2 was transferred to FB3. In FB3 the product was cooled to ambient temperature before final discharge to the packaging room. As discussed above, after leaving the cyclone the nitrogen passed through a filter bag, where finer particles were caught, before entering exhaust fan (F2) and the gas recycling unit from which it was recirculated through loops (1) and/or (2). The exhaust fan speed was adjusted to control the pressure within the system.

Materials

The materials used during the tests are presented in Table 2.

TABLE 2
Materials used during the spray drying studies.

| Material | Supplier |
|---|---|
| VX-950 | RPS-Annan (manufacturer) |
| HPMCAS | SHIN-ETSU (manufacturer) |
| Dichloromethane | ARAGONESAS (manufacturer) |
| (methylene chloride) | |

Analytical Methods

The analytical controls applied were bulk and tap density (e.g., measured by United States Pharmacopeia (USP) method <601>), particle size distribution by typical volumetric laser diffraction (e.g., Malvern Mastersizer, or Sympatec HELOS or MYTOS), and organic solvents (dichloromethane (DCM), acetone and ethyl acetate) by gas chromatography (GC).

Results and Discussion

Spray Drying Tests: Data and Observations

Seven spray drying tests were carried out (five placebo and two active). The principal results are summarized in Table 3. Scanning Electron Microscope (SEM) pictures were taken. Pictures were taken of dispersions prepared with the fines being introduced at the top of the spray dryer and with the fines being introduced at the middle of the spray dryer. Introducing the fines at the top of the spray dryer yielded a more agglomerated product. Introducing the fines at the middle of the spray dryer yielded a less agglomerated product. Pictures were taken at 30×, 100×, and 300× magnifications.

TABLE 3
Results of fluidized spray drying.

| Test number | | | | | | |
|---|---|---|---|---|---|---|
| 01 | 02 | 03 | 04 | 05 | 06 | 07 |

| Formula | |
|---|---|
| placebo | active |

Feed properties and spray drying parameters

| | | | | | | | | |
|---|---|---|---|---|---|---|---|---|
| Feed used | kg | 681 | 432 | 205 | 243 | 243 | 88 | 62 |
| C_feed | % w/w | 4.0 | 4.0 | 4.0 | 4.0 | 4.0 | 20.0 | 20.0 |
| Feed viscosity | Cp | 27.2 | 27.2 | 27.2 | 27.2 | 27.2 | N/A | N/A |
| T_in | ° C. | 75 ± 3 | 90 | 85 ± 2 | 71 ± 1 | 70 ± 1 | 75 ± 3 | 75 ± 3 |
| T_out | ° C. | 40 ± 1 | 40 | 40 | 30 ± 1 | 31 ± 3 | 35 ± 5 | 43 ± 2 |
| ΔP cyclone | cm H₂O | 15-18 | 15-18 | 11-13 | 10-14 | 10-13 | 10-12 | 15-18 |
| P_feed_SP | bar | 22 | 40 | 22 | 22 | 22 | 22 | 22 |
| Drying time | min | 210 | 115 | 74 | 91 | 89 | 35 | 25 |
| F_feed | kg/h | 195 | 225 | 166 | 175 | 164 | 151 | 149 |
| FR position | — | Top | Top | Top | Top | Middle | Middle | Middle |
| T_FB1_SP | ° C. | 80 | 90 | 90 | 90 | 90 | 90 | 90 |
| T_FB2_SP | ° C. | 80-90 | 90 | 90 | 90 | 90 | 90 | 90 |
| T_FB3_SP | ° C. | 0 | 0 | 0 | 0 | 0 | 0 | 0 |
| V_FB1, 2, 3 | % open | 25, 25, 50 | 25, 25, 50 | 25, 25, 50 | 25, 25, 50 | 25, 25, 50 | 25, 25, 50 | 25, 25, 50 |
| VT-FB | % | 10 | 10 | 5 | 4 | 4 | 4 | 30 |

Process throughput and yield

| | | | | | | | | |
|---|---|---|---|---|---|---|---|---|
| F_solids^{a)} | kg/h | 7.8 | 9.0 | 6.6 | 7.0 | 6.6 | 30.2 | 29.8 |
| Yield^{b)} | % w/w | 77 | | | | | 135 | |

Product properties*

| | | | | | | | | |
|---|---|---|---|---|---|---|---|---|
| Sample Number | | 338691 | 338693 | 339695 | 338699 | 338699 | 338702 | 338703 |
| Bulk density | g/ml | 0.14 | 0.13 | 0.14 | 0.17 | 0.20 | 0.32 | 0.25 |
| Tap density | g/ml | 0.18 | 0.18 | 0.19 | 0.23 | 0.25 | 0.41 | 0.32 |
| d10 | μm | 123.73 | 116.25 | 106.58 | 129.03 | 94.16 | 16.47 | 13.37 |
| d50 | μm | 238.95 | 245.35 | 225.08 | 258.54 | 186.07 | 60.03 | 51.45 |
| d90 | μm | 413.05 | 456.44 | 419.83 | 487.94 | 338.51 | 151.05 | 141.67 |
| Span | — | 1.21 | 1.39 | 1.39 | 1.39 | 1.31 | 2.24 | 2.49 |
| D[4, 3] | μm | 255.74 | 267.88 | 245.93 | 286.44 | 203.07 | 80.01 | 86.72 |
| Type of | | Unimodal | Unimodal | Unimodal | Unimodal | Unimodal | Unimodal | Unimodal |
| distribution | | | | | | | | |
| DCM | ppm | 60819 | 59223 | 63204 | 64934 | 68804 | 50612 | 39906 |
| Acetone | ppm | 60 | 63 | 77 | 68 | 71 | 102 | 111 |
| Ethyl acetate | ppm | 5 | 5 | 5 | 5 | 6 | 350 | 395 |

^{a)}F_solids (=_feed × C_feed) is the flow of solid material fed to the spray dryer.
^{b)}Yields have a large error, as the dryer was not cleaned between tests.

### Example 2

This example provides the results of experiments in which a dispersion of VX-950 prepared by fluidized spray drying was directly compressed into a tablet.

Introduction

Tableting properties can be affected by many factors such as physical-chemical and mechanical properties of API, related excipients, and process parameters. To achieve robust formulation, these effects are evaluated during the formulation development stage. These experiments evaluated the effects of a dispersion spray dried via fluidized spray drying with different methods of Vitamin E addition (spray congealed, BASF Vit E acetate, melt granulated onto excipients, and melt granulated onto the dispersion). Tableting properties were characterized by tablet hardness, ejection force, and thickness.

Methods

The addition of different types of Vit E and different processes for the addition of the Vit E were evaluated. The types of Vit E and methods of addition to the dispersion are shown below.

A dispersion of VX-950 was prepared by fluidized spray drying as described herein.

TABLE 4
VX950 SD Tableting Experiment Design (Potency: 250 mg VX950)

| Trial # | Vit E type | Vit E type |
|---|---|---|
| A | VitE-TPGS (24 mg) | Granulated VitE on excipients |
| C | VitE-Acetate (48 mg) | Used as is |
| E | Vit E-TPGS(24 mg) | Vit E Spray Congealed |
| F | Vit E-TPGS (24 mg) | Granulated Vit E onto VX950 |

TABLE 5
Trial# A Formulation

| | | Wt/Tablet | | Theoretical |
|---|---|---|---|---|
| Item | Ingredients | (mg) | % | Qt. (g) |
| | Physical mixture | | | |
| 1 | Solid Dispersion | 339.9 | 66.32 | 19.90 |
| | (73.55% VX950/26.45% HPMCAS) | | | |
| 2 | PHARMATOSE ® DCL 22 (Lactose) | 37.5 | 7.32 | 2.20 |
| 3 | AC-DI-SOL ® (Cross carmellose sodium) | 24.0 | 4.68 | 1.40 |
| 4 | Sodium Stearyl Fumarate | 1.6 | 0.32 | 0.10 |
| 5 | SLS | 3.4 | 0.66 | 0.20 |
| 6 | AVICEL ® pH 113 (Microcrystalline | 33.7 | 6.58 | 1.97 |
| | cellulose) | | | |
| 7 | Vitamin E TPGS (granulated on excipients) | 24.0 | 4.68 | 1.40 |
| 8 | AC-DI-SOL ® (Cross carmellose sodium) | 16.0 | 3.12 | 0.94 |
| 9 | Cabosil M-5 (Colloidal silicon dioxide) | 8.0 | 1.56 | 0.47 |
| 10 | Sodium Stearyl Fumarate | 24.4 | 4.76 | 1.43 |
| | Total | 512.5 | 100 | 30.00 |

Note:
VX 950 SD Lot 02
Potency: 250 mg VX950

TABLE 6
Trial# C Formulation

| | | Wt/Tablet | | Theoretical |
|---|---|---|---|---|
| Item | Ingredients | (mg) | % | Qt. (g) |
| | Physical mixture | | | |
| 1 | Solid Dispersion | 339.9 | 63.36 | 79.19 |
| | (73.55% VX950/26.45% | | | |
| | HPMCAS) | | | |
| 2 | PHARMATOSE ® DCL 22 | 37.5 | 6.99 | 8.74 |
| | (Lactose) | | | |
| 3 | AC-DI-SOL ® (Cross | 24.0 | 4.47 | 5.59 |
| | carmellose sodium) | | | |
| 4 | Sodium Stearyl Fumarate | 1.6 | 0.30 | 0.38 |
| 5 | SLS | 3.4 | 0.63 | 0.79 |
| 6 | AVICEL ® pH 113 | 33.7 | 6.28 | 7.85 |
| | (Microcrystalline cellulose) | | | |
| 7 | Vitamin E-Acetate | 48.0 | 8.95 | 11.18 |
| 8 | AC-DI-SOL ® (Cross | 16.0 | 2.98 | 3.73 |
| | carmellose sodium) | | | |
| 9 | Cabosil M-5 (Colloidal silicon | 8.0 | 1.49 | 1.86 |
| | dioxide) | | | |
| 10 | Sodium Stearyl Fumarate | 24.4 | 4.54 | 5.68 |
| | Total | 536.5 | 100 | 125.00 |

TABLE 7
Trial# E Formulation

| | | Wt/Tablet | | Theoretical |
|---|---|---|---|---|
| Item | Ingredients | (mg) | % | Qt. (g) |
| | Physical mixture | | | |
| 1 | Solid Dispersion | 339.9 | 66.32 | 82.90 |
| | (73.55% VX950/26.45% | | | |
| | HPMCAS) | | | |
| 2 | PHARMATOSE ® DCL 22 | 37.5 | 7.32 | 9.15 |
| | (Lactose) | | | |
| 3 | AC-DI-SOL ® (Cross | 24.0 | 4.68 | 5.85 |
| | carmellose sodium) | | | |
| 4 | Sodium Stearyl Fumarate | 1.6 | 0.32 | 0.40 |
| 5 | SLS | 3.4 | 0.66 | 0.83 |
| 6 | AVICEL ® pH 113 | 33.7 | 6.58 | 8.22 |
| | (Microcrystalline cellulose) | | | |
| 7 | Vitamin E Spray Congealed | 24.0 | 4.68 | 5.85 |
| 8 | AC-DI-SOL ® (Cross | 16.0 | 3.12 | 3.90 |
| | carmellose sodium) | | | |
| 9 | Cabosil M-5 (Colloidal silicon | 8.0 | 1.56 | 1.95 |
| | dioxide) | | | |
| 10 | Sodium Stearyl Fumarate | 24.4 | 4.76 | 5.95 |
| | Total | 512.5 | 100 | 125.00 |

Note:
VX 950 SD Lot 02
Potency: 250 mg VX950

TABLE 8
Trial# F Formulation

| | | Wt/Tablet | | Theoretical |
|---|---|---|---|---|
| Item | Ingredients | (mg) | % | Qt. (g) |
| 1 | Solid Dispersion | 339.9 | 66.32 | 66.32 |
| | (73.55% VX950/26.45% | | | |
| | HPMCAS) | | | |
| 2 | Vitamin E granulated onto | 24.0 | 4.68 | 4.68 |
| | dispersion | | | |
| 3 | PHARMATOSE ® DCL 22 | 37.5 | 7.32 | 7.32 |
| | (Lactose) | | | |
| 4 | AC-DI-SOL ® (Cross | 24.0 | 4.68 | 4.68 |
| | carmellose sodium) | | | |
| 5 | Sodium Stearyl Fumarate | 1.6 | 0.32 | 0.32 |
| 6 | SLS | 3.4 | 0.66 | 0.66 |
| 7 | AVICEL ® pH 113 | 33.7 | 6.58 | 6.58 |
| | (Microcrystalline cellulose) | | | |
| 8 | AC-DI-SOL ® (Cross | 16.0 | 3.12 | 3.12 |
| | carmellose sodium) | | | |
| 9 | Cabosil M-5 (Colloidal silicon | 8.0 | 1.56 | 1.56 |
| | dioxide) | | | |
| 10 | Sodium Stearyl Fumarate | 24.4 | 4.76 | 4.76 |
| | Total | 512.5 | 100 | 100.00 |

Note:
VX 950 SD Lot 02
Potency: 250 mg VX950

TABLE 9
VX 950 SD Lot 02 Physical parameters

| | |
|---|---|
| D10 (μm) | 13.37 |
| D50 (μm) | 51.45 |
| D90 (μm) | 141.67 |
| Bulk density (g/ml) | 0.25 |
| Tap density (g/ml) | 0.32 |

Results

TABLE 10
Results from the Compression Run

| | | | Tooling shape: | | | | | |
|---|---|---|---|---|---|---|---|---|
| | Tablet wt. = | | oval 0.6250 in.* | | | | | |
| | 512.5 mg | | 0.3750 in. | | | | | |
| #A-GranExcp-DC | Run #1 | Run #2 | Run #3 | Run #4 | Run #5 | Run #6 | Run #7 | Run #8 |
| Compress force | 2.37 | 2.7 | 2.84 | 4.43 | 6.95 | 8.4 | 12.5 | 16.01 |
| (kN) | | | | | | | | |
| Eject (N) | 70 | 83 | 83 | 86 | 90 | 90 | 90 | 90 |
| Hardness (kp) | 3 | 3.2 | 3.3 | 4.8 | 6.5 | 8.5 | 10.5 | 10.8 |
| Thickness (mm) | 6.97 | 6.46 | 6.43 | 6.02 | 5.76 | 5.51 | 5.35 | 5.30 |

| | | | | Tooling shape: | | | | | |
|---|---|---|---|---|---|---|---|---|---|
| | Tablet wt. = | | | oval 0.6250 in.* | | | | | |
| | 536.5 mg | | | 0.3750 in. | | | | | |
| #C-Acet-DC | Run #1 | Run #2 | Run #3 | Run #4 | Run #5 | Run #6 | Run #7 | Run #8 | Run #9 |
| Compress force | 1.1 | 1.9 | 2.3 | 2.8 | 4.4 | 6.8 | 10.1 | 13.4 | 18.1 |
| (kN) | | | | | | | | | |
| Eject (N) | 83 | 83 | | | | | | | |
| Hardness (kp) | N/A | 2.3 | 2.5 | 2.7 | 4.4 | 6.5 | 9.9 | 13.3 | 14.5 |
| Thickness (mm) | 8.30 | 7.70 | 7.38 | 7.05 | 6.48 | 6.03 | 5.76 | 5.60 | 5.52 |

| | | | Tooling shape: | | | | |
|---|---|---|---|---|---|---|---|
| | Tablet wt. = | | oval 0.6250 in.* | | | | |
| | 512.5 mg | | 0.3750 in. | | | | |
| | Run #1 | Run #2 | Run #3 | Run #4 | Run #5 | Run #6 | Run #7 |
| #E-SpCong-DC | | | | | | | |
| Compress force | 1.77 | 2.23 | 3.68 | 5.61 | 8.8 | 15.5 | 18.09 |
| (kN) | | | | | | | |
| Eject (N) | 83 | 83 | 90 | 95 | 120 | 95 | 95.00 |
| Hardness (kp) | 2 | 2.4 | 3.6 | 6.1 | 10.4 | 14 | 14.23 |
| Thickness (mm) | 7.46 | 7.06 | 6.42 | 6.01 | 5.53 | 5.33 | 5.29 |
| #F-Gran | | | | | | | |
| VX950-DC | | | | | | | |
| Compress force | 2.18 | 3.37 | 4.41 | 6.27 | 10.28 | 12.8 | 18.83 |
| (kN) | | | | | | | |
| Eject (N) | 75 | 83 | 83 | 85 | 90 | 90 | 90 |
| Hardness (kp) | 1.5 | 3.4 | 5.6 | 7.8 | 11.2 | 13.8 | 15.6 |
| Thickness (mm) | 6.98 | 6.44 | 6.00 | 5.81 | 5.55 | 5.37 | 5.28 |

TABLE 11
Blend Properties

| Flowability test | Flow index | Carr index |
|---|---|---|
| #A-GranExcp-DC | 9 | 31.1 |
| #C-Acet-DC | 14 | 34.9 |
| #E-SpCong-DC | 12 | 29.3 |
| #F-GranVX950-DC | 12 | 41.0 |
| Bulk/Tap Density | Bulk (g/ml) | Tap (g/ml) |
| #A-GranExcp-DC | 0.31 | 0.46 |
| #C-Acet-DC | 0.28 | 0.43 |
| #E-SpCong-DC | 0.31 | 0.43 |
| #F-GranVX950-DC | 0.36 | 0.61 |

A number of embodiments of the invention have been described. Nevertheless, it will be understood that various modifications may be made without departing from the scope of the invention. Accordingly, other embodiments are within the scope of the following claims.

What is claimed is:

1. A method of fluidized spray drying VX-950, the method comprising:
preparing a liquid feed solution comprising VX-950;
atomizing the feed solution upon delivery into the drying chamber of a spray dryer operating in fluidized spray drying mode;
drying the feed solution in the drying chamber with heated air or a heated gas to obtain a product, wherein larger particles of product separate out, while fines are carried by a stream of air or gas up to the top of the drying chamber and to a cyclone, and
re-introducing the fines into the drying chamber, wherein the re-introduced fines can agglomerate with newly formed product to generate an agglomerated product, wherein if the agglomerated product is large enough, it will separate out, if it is not large enough to separate out, the agglomerated product will be carried by convection to the top of the chamber and to the cyclone and re-introduced into the chamber.

2. The method of claim 1 further comprising collecting the agglomerated product in a first fluidizing chamber.

3. The method of claim 2 further comprising discharging the agglomerated product from the first fluidizing chamber to a second fluidizing chamber, wherein a post-drying process occurs.

4. The method of claim 3 further comprising transferring the agglomerated product from the second fluidizing chamber to a third fluidizing chamber, wherein the agglomerated product is cooled.

5. The method of claim 1, wherein the fines are re-introduced into the drying chamber coaxially surrounding the liquid flow of feed solution.

6. The method of claim 1, wherein the fines are re-introduced tangentially to the drying chamber.

7. The method of claim 1, wherein the feed solution is dried with a gas and the gas is nitrogen.

8. The method of claim 1, wherein the VX-950 comprises between about 10% and 90% by weight of solids dissolved in the feed solution.

9. The method of claim 1, wherein the feed solution comprises a solvent.

10. The method of claim 9, wherein the solvent comprises methylene chloride.

11. The method of claim 9, wherein the solvent comprises acetone.

12. The method of claim 9, wherein the solvent comprises methylene chloride and acetone.

13. The method of claim 12, wherein the solvent comprises from about 0% to about 30% acetone and from about 70% to about 100% methylene chloride.

14. The method of claim 12, wherein the solvent comprises from about 0% to about 40% acetone and from about 60% to about 100% methylene chloride.

15. The method of claim 9, wherein the solvent comprises a non-volatile solvent.

16. The method of claim 1, wherein the feed solution comprises a surfactant.

17. The method of claim 16, wherein the surfactant comprises vitamin E or a derivative thereof.

18. The method of claim 16, wherein the surfactant is present in an amount of between about 0.1% and about 10%.

19. The method of claim 1, wherein the feed solution comprises a plurality of polymers.

20. The method of claim 19, wherein the polymers comprise between about 10% and 90% of the solids dissolved in the feed solution.

21. The method of claim 19, wherein the plurality of polymers comprises a cellulose polymer.

22. The method of claim 21, wherein the cellulose polymer is hydroxypropylmethylcellulose (HPMC).

23. The method of claim 21, wherein the cellulose polymer is hydroxypropylmethylcellulose acetate succinate (HPMCAS).

24. The method of claim 19, wherein the plurality of polymers comprises two cellulose polymers.

25. The method of claim 24, wherein one of the two cellulose polymers is hydroxypropylmethylcellulose (HPMC).

26. The method of claim 24, wherein one of the two cellulose polymers is hydroxypropylmethylcellulose acetate succinate (HPMCAS).

27. The method of claim 24, wherein the plurality of polymers comprises HPMC and HPMCAS.

28. The method of claim 27, wherein the feed solution comprises a surfactant or excipient.

29. The method of claim 28, wherein the surfactant is SLS or vitamin E or a derivative thereof.

30. The method of claim 28, wherein the surfactant is SLS.

31. The method of claim 28 wherein the surfactant is vitamin E or a derivative thereof.

32. The method of claim 1, wherein the feed solution comprises a polymer.

33. The method of claim 33, wherein the polymer comprises between about 10% and 90% of the solids dissolved in the feed solution.

34. The method of claim 34, wherein the feed solution further comprises a surfactant or excipient.

35. The method of claim 36, wherein the surfactant is sodium lauryl sulfate (SLS) or vitamin E or a derivative thereof.

36. The method of claim 34, wherein the surfactant is SLS.

37. The method of claim 34, wherein the surfactant is vitamin E or a derivative thereof.

38. The method of claim 37, wherein the surfactant is present in an amount of between about 0.1% and about 10%.

39. The method of claim 32, wherein the polymer comprises a cellulose polymer.

40. The method of claim 39, wherein the cellulose polymer is hydroxypropylmethylcellulose (HPMC).

41. The method of claim 39, wherein the cellulose polymer is hydroxypropylmethylcellulose acetate succinate (HPMCAS).
